(19) United States
(12) Patent Application Publication
(10) Pub. No.: US 2011/0304801 A1
(43) Pub. Date: Dec. 15, 2011

(54) LIQUID CRYSTAL DISPLAY PANEL

(75) Inventor: Satoshi Shibata, Osaka (JP)

(73) Assignee: SHARP KABUSHIKI KAISHA, Osaka (JP)

(21) Appl. No.: 13/148,390

(22) PCT Filed: Nov. 19, 2009
(86) PCT No.: PCT/JP2009/069614

§ 371 Date: Aug. 9, 2011

(30) Foreign Application Priority Data
Feb. 9, 2009 (JP) 2009-027619

(51) Int. Cl. G02F 1/1335

(52) U.S. Cl. 349/96

(57) ABSTRACT

A rear-side polarizing plate 32 is provided on the side of a rear-side substrate 22 not facing a liquid crystal layer 26, a front-side polarizing plate 34 is provided on the side of a front-side substrate 24 not facing the liquid crystal layer 26, an in-cell polarizing plate 50 is provided on the side of the front-side substrate 24 facing the liquid crystal layer 26, and a rear-side phase difference film 36 is provided between the rear-side polarizing plate 32 and the in-cell polarizing plate 50 in order to compensate for viewing angle in regard to contrast.

### TECHNICAL FIELD

The present invention relates to liquid crystal display panels provided with a polarizing plate in a liquid crystal cell.

### BACKGROUND ART

Because they are thin, lightweight and have low power consumption, liquid crystal display panels have become widely used in recent years in place of CRT or similar display devices.

The aforementioned liquid crystal display panel usually has a liquid crystal cell and a polarizing plate. Generally, the polarizing plate that is arranged on the outside of the liquid crystal cell has a protective film and a polarizing film, and a polarizing film made from polyvinyl alcohol film is dyed with iodine, elongated and both sides are layered with a protective film (not shown in the figure) made from TAC (triacetyl cellulose) or similar substance.

A more detailed explanation is provided below based on FIG. 24, which is a figure showing a schematic configuration of a conventional liquid crystal display panel 10.

As shown in FIG. 24, for example, the transmissive liquid crystal display panel 10 has a configuration in which the polarizing plates (rear-side polarizing plate 32, front-side polarizing plate 34) are provided respective sides of the liquid crystal cell 20.

The liquid crystal cell 20 has a configuration in which the liquid crystal layer 26, which contains liquid crystal molecules (not shown in figure), is held between two substrates (rear-side substrate 22, front-side substrate 24).

Additionally, if, for example, the liquid crystal display panel 10 has been configured as the active matrix liquid crystal display panel 10, which can display color, one of the two substrates will be an array substrate and the other will be a color filter substrate. FIG. 24 shows an example configured with the front-side substrate 24 as the color filter substrate.

The color filter 28 is provided on the side facing the liquid crystal layer 26 on the front-side substrate 24, which serves as the color filter substrate,

Note that the terms rear and front are not particularly restricted, but generally, in a transmissive liquid crystal display panel, the back is where the backlight is provided and the front is the side that the viewer of the liquid crystal display panel will face.

### RELATED ART DOCUMENTS

### Patent Documents

Patent Document 1: Japanese Patent Application Laid-Open Publication No. 2006-91393 (Publication Date: Apr. 6, 2006)

Patent Document 2: Japanese Patent Application Laid-Open Publication No. 2007-199237 (Publication Date: Aug. 9, 2007)

### SUMMARY OF THE INVENTION

### Problems to be Solved by the Invention

Here, the liquid crystal display panel 10 has a problem of contrast that is dependent on the viewing angle. Below is provided an explanation of the primary factors that cause viewing angle dependence in the contrast, which are axis deviation of the polarization panels and oblique phase difference of the liquid crystal layer.

Axis Deviation of the Polarizing Plate

First, an explanation is provided of the axis deviation of the polarizing plate based on FIGS. 25(a) and (b). Here, both FIGS. 25(a) and 25(b) are figures showing the angle of intersection of the absorption axes (absorption axis D2 of the rear-side polarizing plate 32, absorption axis D4 of the front-side polarizing plate) of the two polarizing plates (rear-side polarizing plate 32, front-side polarizing plate 34), FIG. 25(a) shows the liquid crystal display panel 10 viewed from the front direction (front view) and FIG. 25(b) shows the liquid crystal display panel 10 viewed from an oblique direction (oblique view). Note also that the term “front direction” of the liquid crystal display panel 10 means the normal direction with respect to the liquid crystal display panel 10.

As shown in FIG. 25(b), when the liquid crystal display panel 10 is observed from an oblique direction, the angle of intersection (θ2) of the absorption axes (absorption axis D2 of the rear-side polarizing plate 32, absorption axis D4 of the front-side polarizing plate) of the two polarizing plates (rear-side polarizing plate 32, front-side polarizing plate 34) is smaller than the angle of intersection (θ1) when observed from the front direction shown in FIG. 25(a). More specifically, when viewed from the front direction, the angle of intersection (θ1) is 90°, while when viewed from an oblique direction, that angle of intersection (θ2) is not 90°, but an angle that is smaller.

This indicates that the two polarizing plates are not in a Cross-Nicol arrangement. And, because the polarizing plates are not in a Cross-Nicol arrangement, a good black display is impossible, causing what is known as “black lift.”

This manifestation of black lift is a factor in causing viewing angle dependence in the contrast.

Liquid Crystal Layer Oblique Phase Difference

Next, we will explain the oblique phase difference of the liquid crystal layer, which is the second factor in bringing about viewing angle dependence in the contrast.

For instance, when the liquid crystal molecules contained in the liquid crystal layer are in vertical direction, the phase difference of the liquid crystal layer will be nearly zero when viewed from the front direction. Conversely, when viewed from the oblique direction, there will be a phase difference in the liquid crystal layer.

Due to the phase difference that is generated in the liquid crystal layer, the polarized state of the light passing through the liquid crystal cell will change. This change in the polarized state of the light is the second factor that causes viewing angle dependence in the contrast.

Polarizing Plate Viewing Angle Compensation

Thus, optical compensation is required to reduce the viewing angle dependence in the contrast.

There are a variety of viewing angle compensation methods, particularly for compensating the black viewing angle.

Phase Difference Film, TAC

For example, FIG. 26 shows a configuration for compensating the viewing angle dependence using phase difference film or similar means. Here, FIG. 26 is a cross section diagram showing a schematic configuration of the liquid crystal display panel 10 after compensating for the viewing angle dependence using phase difference films (rear-side phase difference film 36 and front-side phase difference film 44).

The B, G and R shown in the color filter 28 in FIG. 26 mean blue, green and red, respectively.

A protective film made of TAC (triacetyl cellulose) may be used for the phase difference films (rear-side phase difference film 36, front-side phase difference film 44).

The viewing angle compensation is performed with the liquid crystal display panel 10 using phase difference films, which are placed between the liquid crystal cell 20 and the polarizing plates provided on the outside of the liquid crystal cell 20, as shown in FIG. 26. More specifically, the rear-side phase difference film 36 is provided between the rear-side substrate of the liquid crystal cell 20 and the rear-side polarizing plate 32. In the same manner, front-side phase difference film 44 is provided between the front-side substrate of the liquid crystal cell 20 and the front-side polarizing plate 34.

In the liquid crystal display panel 10 configured above, the viewing angle dependence compensation takes place between the two polarizing plates (the rear-side polarizing plate 32 and the front-side polarizing plate 34, (between the outer polarizing plates L1) provided on the outside of the liquid crystal cell 20.

In-Cell Polarizing Plate

A configuration that uses an in-cell polarizing plate as a configuration for improving the contrast of the liquid crystal display panel 10 has been considered. Below is provided an explanation of this configuration based on FIG. 27. FIG. 27 is a cross-section diagram showing a schematic configuration of the liquid crystal display panel 10 where the viewing angle dependence compensation is performed by providing the in-cell polarizing plate 50. Here, for the sake of simplicity, a phase difference film and TAC that act as a protective film for the polarizing plates are not shown.

Here, the in-cell polarizing plate 50 is not provided outside the liquid crystal cell 20, but is provided inside the liquid crystal cell 20. More specifically, this means that the polarizing plate is provided in the area between the two liquid crystal cell 20 substrates (rear-side substrate 22, front-side substrate 24).

As shown in FIG. 27, liquid crystal display panel 10, which has been equipped with the in-cell polarizing plate 50, has almost the same configuration as the liquid crystal display panel 10 described based on FIG. 24. The difference is that the in-cell polarizing plate 50 has been provided between the color filter 28 and the liquid crystal layer 26. In other words, in the liquid crystal display panel 10 shown in FIG. 27, the color filter 28 has been provided on the inside surface, which is the side facing the rear-side substrate 22 of the front-side substrate 24, and the in-cell polarizing plate 50 has been provided on the color filter 28. Note also that on the liquid crystal display panel 10, the two polarizing plates (rear-side polarizing plate 32, front-side polarizing plate 34) provided on the outside of the liquid crystal cell 20 are provided in the same position as the liquid crystal display panel 10 described previously based on FIG. 24. Thus, the liquid crystal display panel 10 shown in FIG. 24 has been provided with three polarizing plates (the rear-side polarizing plate 32, the front-side polarizing plate 34 and the in-cell polarizing plate 50).

The front direction contrast can be improved by providing the in-cell polarizing plate 50. Below is provided an explanation.

Generally, the color filter 28 has the effect of eliminating the transmitted polarized light. More specifically, when polarized light that is incident to the color filter 28 passes through the color filter 28, the polarized light is eliminated. In other words, the color filter 28 functions as a depolarizing layer.

The polarized light that is eliminated when the light passes through the color filter 28 causes light leakage when it passes through the front-side polarizing plate 34, which functions as an analyzer.

Here, in the liquid crystal display panel 10, which has been provided with the in-cell polarizing plate 50, before the light that passes through the liquid crystal layer 26 enters the color filter 28, it enters the in-cell polarizing plate 50, which acts as an analyzer. Thus, the light that has not passed through the color filter 28, which functions as a depolarizing layer, can be used to achieve a black and white display, allowing the realization of higher contrast.

In other words, in the liquid crystal display panel 10 equipped with the in-cell polarizing plate 50, the polarized light that enters the color filter 28 can be reduced to a minimum, allowing the achievement of higher contrast.

Note also that the placement of a polarizing plate inside the liquid crystal cell is mentioned in Patent Document 1 and Patent Document 2.

Contrast Viewing Angle

As described above, in the liquid crystal display panel 10 equipped with the in-cell polarizing plate 50, although higher contrast can be achieved, the increase is limited to the front direction. In other words, although the front direction contrast can be heightened by providing the liquid crystal display panel 10 with the in-cell polarizing plate 50, there are times when the oblique direction contrast is degraded.

For that reason, an optical compensation process is required in order to suppress the deterioration in oblique direction contrast or, the deterioration in contrast viewing angle.

The present invention provides a liquid crystal display panel that can improve not only front direction contrast but oblique direction contrast as well, using a simple configuration.

### Means for Solving the Problems

In order to resolve the problems described above, the liquid crystal display panel of the present invention is a liquid crystal display panel equipped with a first substrate and a second substrate and a liquid crystal layer that is held between the first and second substrates, and on the outside face of the first substrate, which does not face the liquid crystal layer, a first polarizing plate is provided, and the second substrate is provided with a second polarizing plate on the outside face, which is the side that does not face the liquid crystal layer, and on the inner side of the second substrate, which is the side that faces the liquid crystal layer, between the second substrate and the liquid crystal layer, an in-cell polarizing plate is provided, and between the first polarizing plate and the in-cell polarizing plate a viewing angle compensation film is provided. The liquid crystal display panel is characterized by having a phase difference value in the thickness direction of the liquid crystal layer between the first polarizing plate and the second polarizing plate that is smaller than the phase difference value in the thickness direction of the liquid crystal layer between the first polarizing plate and the in-cell polarizing plate.

This configuration has a polarizing plate (in-cell polarizing plate) between the substrate and the liquid crystal layer on the inner side of one of the substrates. And, the in-cell polarizing plate also functions as an analyzer.

Because of this, the analyzer is located near the liquid crystal layer, which makes it possible to achieve a liquid crystal display panel with a high degree of contrast, especially for contrast in the front direction.

Also, even if one of the substrates is equipped with a layer that will serve as a depolarizing layer, like a color filter, for example, a polarizer and an analyzer can be formed with just two polarizing plates without going through the depolarizing layer.

For example, if one of the substrates is equipped with a color filter, then by equipping that substrate with an in-cell polarizing plate and by placing the color filter between that substrate and the in-cell polarizing plate, a polarizer and an analyzer can be configured with the in-cell polarizing plate and the polarizing plate on the other substrate without going through the depolarizing layer (color filter). In this case, the polarizing plate in the other substrate serves as a polarizer and the in-cell polarizing plate acts as an analyzer.

Because the light can be guided to the analyzer without passing through the depolarizing layer, it is possible to suppress the deterioration in contrast caused by transmission through the depolarizing layer.

Additionally, with this configuration, there is a viewing angle compensation film between the first polarizing plate and the in-cell polarizing plate with this liquid crystal display panel, which is equipped with three polarizing plates: a first polarizing plate, a second polarizing plate and an in-cell polarizing plate.

More specifically, between the polarizing plate provided on the outside of one of the substrates and the polarizing plate (in-cell polarizing plate) provided on the inner side of the other substrate, there is a liquid crystal layer along with a viewing angle compensation film. In other words, between the first polarizing plate, which functions as a polarizer, and an in-cell polarizing plate that functions as an analyzer, there is a viewing angle compensation film. Because of this, in addition to making it easier to compensate for the contrast viewing angle, it is also possible to accomplish compensation for a wider viewing angle.

Also, with this configuration, the value of the phase difference between the first polarizing plate and the second polarizing plate is smaller than the value of the phase difference between the first polarizing plate and the in-cell polarizing plate.

For that reason, even if a member having a phase difference is placed between the in-cell polarizing plate and the second polarizing plate, it is easy to achieve excellent viewing angle characteristics. More specifically, for example, even if a TAC film is provided to protect the second polarizing plate, it is still easy to have excellent viewing angle compensation.

As stated, with this liquid crystal display panel configuration, it is possible to achieve a simple configuration that improves contrast not only in the front direction, but in the oblique directions as well.

### Effects of the Invention

As described above, the liquid crystal display panel of the present invention has a first polarizing plate provided on the outside face of the first substrate not facing the liquid crystal layer, a second polarizing plate provided on the outside face of the second substrate not facing the liquid crystal layer, an in-cell polarizing plate provided on the inner side of the second substrate facing the liquid crystal layer between the second substrate and the liquid crystal layer, and a viewing angle compensation film provided between the first polarizing plate and the in-cell polarizing plate, whereby the contrast viewing angle compensation is achieved.

Hence, the effect achieved is that a liquid crystal display panel can be provided with a simple configuration that is capable of improving contrast, not only in a front direction, but also in oblique directions as well.

### BRIEF DESCRIPTION OF THE DRAWINGS

FIG. 1 shows an embodiment of the present invention and it is a cross-section diagram showing a schematic configuration of the layers of a liquid crystal display panel.

FIG. 2 is a cross-section diagram showing a schematic configuration of the layers of a liquid crystal display panel of Comparison Configuration A.

FIG. 3 is a cross-section diagram showing a schematic configuration of the layers of a liquid crystal display panel of Comparison Configuration B.

FIG. 4 is a diagram showing the viewing angle compensation of the liquid crystal display panel of Comparison Configuration A on a Poincare sphere.

FIG.5 is a diagram showing the optical characteristics of the liquid crystal display panel of Comparison Configuration A. FIG. 5(a) is an iso-contrast chart and FIG. 5(b) is a black luminance chart.

FIG. 6 is a diagram showing the viewing angle compensation of the liquid crystal display panel of Comparison Configuration B on a Poincare sphere.

FIG. 7 is a diagram showing the optical characteristics of the liquid crystal display panel of Comparison Configuration B, FIG. 7(a) is an iso-contrast chart and FIG. 7(b) is a black luminance chart.

FIG. 8 shows an embodiment of the present invention and is a cross-section diagram showing a schematic configuration of the layers of a liquid crystal display panel of Embodiment 1.

FIG. 9 shows an embodiment of the present invention and is a cross-section diagram showing a showing the viewing angle compensation of a liquid crystal display panel of Embodiment 1 on a Poincare sphere.

FIG. 10 is a diagram showing the optical characteristics of liquid crystal display panels, FIGS. 10(a) to 10(c) show the optical characteristics of the liquid crystal display panel of Embodiment 1 and FIGS. 10(d) to 10(f) show the optical characteristics of the liquid crystal display panel of Comparison Configuration A.

FIG. 11 is a diagram showing the optical characteristics of a liquid crystal display panel, and shows a black luminance chart when the negative C plate retardation is varied.

FIG. 12 is shows another embodiment of the present invention and is a cross-section diagram showing a schematic of the layer configuration of a liquid crystal display panel of Embodiment 2.

FIG. 13 shows another embodiment of the present invention and is a diagram showing the viewing angle compensation of the liquid crystal display panel of Embodiment 2 on a Poincare sphere.

FIG. 14 is a diagram showing the optical characteristics of liquid crystal display panels, FIGS. 14(a) to 14(c) show the optical characteristics of the liquid crystal display panel of

Embodiment 2 and FIGS. 14(d) to 14(f) show the optical characteristics of the liquid crystal display panel of Embodiment 1.

FIG. 15 is a diagram showing the optical characteristics of a liquid crystal display panel and shows a black luminance chart for when retardation of the rear-side 2-axis film is varied.

FIG. 16 shows another embodiment of the present invention and it is a cross-section diagram showing a schematic of the layer configuration of a liquid crystal display panel of Embodiment 3.

FIG. 17 is a cross-section diagram showing a schematic of the layer configuration of the liquid crystal display panel of Comparison Configuration C.

FIG. 18 shows an embodiment of the present invention and is a diagram showing the viewing angle compensation of the liquid crystal display panel of Embodiment 3 on a Poincare sphere.

FIG. 19 is a diagram showing the optical characteristics of a liquid crystal display panel, FIGS. 19(a) to 19(c) show the optical characteristics of the liquid crystal display panel of Embodiment 3 and FIGS. 19(d) to 19(f) show the optical characteristics of the liquid crystal display panel of Comparison Configuration C.

FIG. 20 is a cross-section diagram showing a schematic of the layer configuration of a liquid crystal display panel of Comparison Configuration E.

FIG. 21 is a cross-section diagram showing a schematic of the layer configuration of a liquid crystal display panel of Comparison Configuration D.

FIG. 22 shows the optical characteristics of a liquid crystal display panel, FIGS. 22(a) to 22(c) show the optical characteristics of the liquid crystal display panel of Comparison Configuration E and FIGS. 22(d) to 22(f) show the optical characteristics of the liquid crystal display panel of Comparison Configuration D.

FIG. 23 is a diagram that summarizes the characteristics of each configuration.

FIG. 24 shows the conventional technology and is a cross-section diagram showing a schematic configuration of a liquid crystal display panel.

FIG. 25 is a diagram showing the angle of intersection of the absorption axes of two polarizing plates, FIG. 25(a) shows the front view, and FIG. 25(b) shows the oblique view.

FIG. 26 shows the conventional technology and is a cross-section diagram showing a schematic configuration of a liquid crystal display panel.

FIG. 27 shows the conventional technology and is a cross-section diagram showing a schematic configuration of a liquid crystal display panel.

### DETAILED DESCRIPTION OF EMBODIMENTS

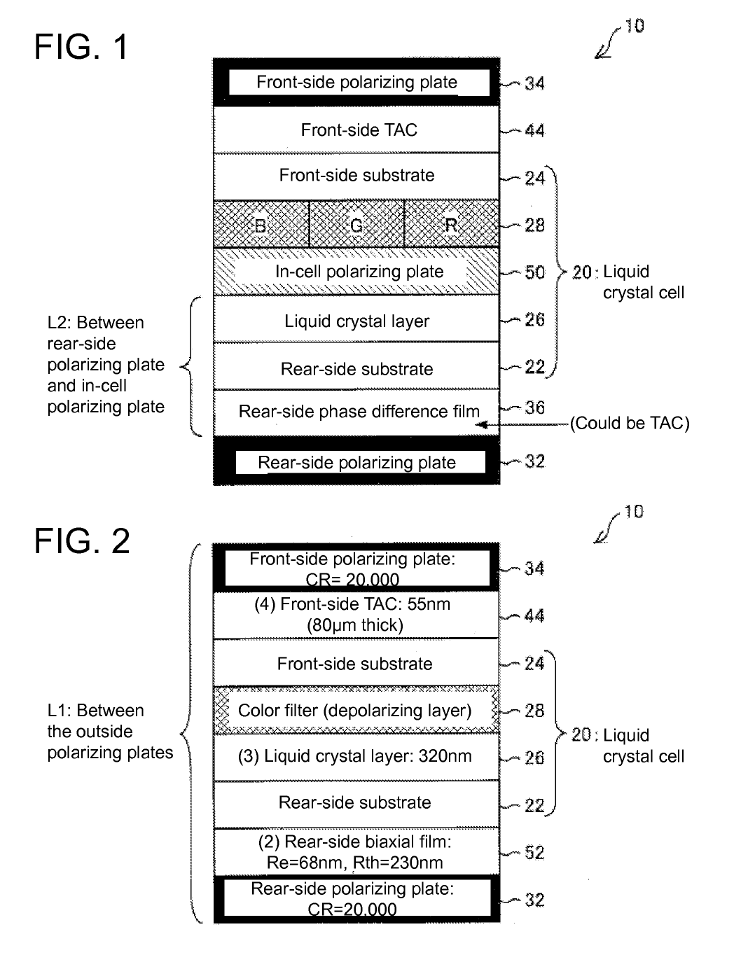

As shown in FIG. 1, features of the liquid crystal display panel 10 of the present invention are such that an in-cell polarizing plate 50 is provided to the liquid crystal cell 20, and optical compensation, more specifically, contrast viewing angle compensation is realized between the rear-side polarizing plate 32 and the in-cell polarizing plate 50 (at L2 between the rear-side polarizing plate and the in-cell polarizing plate).

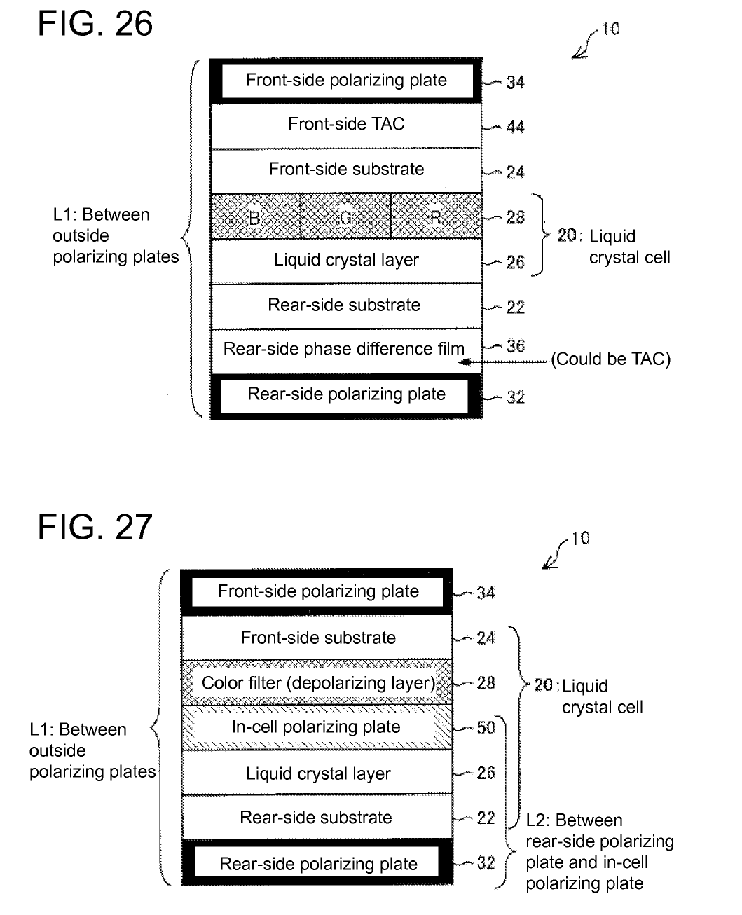

In other words, the liquid crystal display panel 10 of the present invention has a structure similar to the conventional liquid crystal display panel 10 described with reference to FIG. 26. However, in contrast to the conventional liquid crystal display panel 10 shown in FIG. 26 above, where only two plates, the rear-side polarizing plate 32 and the front-side polarizing plate 34 are provided as polarizing plates, the liquid crystal display panel 10 of the present invention differs in that it is provided with the in-cell polarizing plate 50 inside the liquid crystal cell 20 in addition to the two polarizing plates: the rear-side polarizing plate 32 and the front-side polarizing plate 34.

Also, in contrast to the conventional liquid crystal display panel 10 described above, where the optical viewing angle compensation is performed at L1 between the outside polarizing plates, the liquid crystal display panel 10 of the present invention differs in that the viewing angle compensation is performed at L2 between the rear-side polarizing plate and the in-cell polarizing plate. We explain this below.

Note that the following explanation includes optical and other evaluations that have been simulated.

### EMBODIMENT 1

First, an explanation will be provided below of the first embodiment of the present invention based on FIGS. 1 to 11. Also, when explaining the embodiments of the present invention, conventional examples will also be mentioned for the sake of comparison.

As described previously using FIG. 1, the liquid crystal display panel 10 of this embodiment is provided with the in-cell polarizing plate 50 in the liquid crystal cell 20, and viewing angle compensation is realized at L2 between the rear-side polarizing plate and the in-cell polarizing plate.

Comparison Configurations A and B

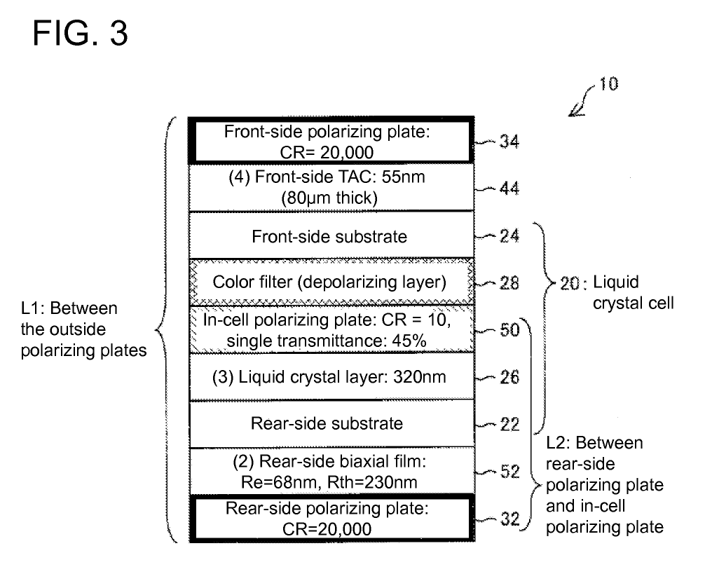

First, in order to draw comparisons with the liquid crystal display panel of the present invention, we will explain a conventional liquid crystal display panel 10 (Comparison Configuration A), which has no in-cell polarizing plate 50, and a conventional liquid crystal display panel 10 (Comparison Configuration B) that has no in-cell polarizing plate 50 but is equipped with a liquid crystal display panel provided with an in-cell polarizing plate 50 without modifying the rest of the configuration with reference to FIGS. 2 and 3.

Here, FIGS. 2 and 3 are cross-section diagrams showing schematics of the layer configuration of the liquid crystal display panels 10 for comparison and FIG. 2 shows the liquid crystal display panel 10 of Comparison Configuration A and FIG. 3 shows the liquid crystal display panel 10 of Comparison Configuration B.

Comparison Configuration A

As shown in FIG. 2 described above, the conventional liquid crystal display panel 10 (Comparison Configuration A) not provided with the in-cell polarizing plate 50 has a configuration in which optical film has been provided on both exterior sides (front side and rear side) of the liquid crystal cell 20.

First, an explanation will be provided of the liquid crystal cell 20. The principal configuration elements of the liquid crystal cell 20 are the two substrates (rear-side polarizing plate 22, front-side polarizing plate 24), the liquid crystal layer 26 and the color filter 28.

And, the liquid crystal layer 26 is configured such that it is in between the two substrates described above. Here, the retardation of the liquid crystal layer 26 is 320 nm and liquid crystals having a refractive anisotropy of 0.1 defined as Δn=ne−no have been used as the liquid crystal material.

Additionally, the front-side substrate 24 is provided the color filter 28, which acts as a depolarizing layer (described above), on a side facing the rear-side substrate 22.

Further, both sides of the liquid crystal cell 20 are provided with an optical film.

More specifically, the front side TAC44 and, on top of it, the front-side polarizing plate 34 are provided on the surface of front-side substrate 24 that is on the opposite side (front side) of the surface facing the rear-side substrate 22. Here, the front-side TAC44 has a thickness of 80 um and a retardation of 55 nm. Also, the front-side polarizing plate 34 contrast (CR) is 20000.

And, the surface of the side (rear side) opposite the surface that faces the front-side substrate 24 at the rear-side substrate 22 is provided the rear-side biaxial film 52 and on top of it, the rear-side polarizing plate 32. Here, the in-plane retardation (Re) of the rear-side biaxial film 52 is 68 nm and the retardation in the thickness direction (Rth) is 230 nm. Additionally, the contrast of the rear-side polarizing plate 32 is 20000, the same as the front-side polarizing plate 34.

Also, the liquid crystal display panel 10 of the Comparison Configuration A accomplishes viewing angle compensation at L1, between the outside polarizing plates (the rear-side polarizing plate 32 and the front-side polarizing plate 34) using the configuration “n” above.

Comparison Configuration B

With the exception of the addition of the in-cell polarizing plate 50 to the liquid crystal display panel 10, the configuration of the liquid crystal display panel 10 of the Comparison Configuration B shown in FIG. 3, is unchanged from the configuration of the liquid crystal display panel 10 of Comparison Configuration A, which has no in-cell polarizing plate 50 and performs viewing angle compensation at L1 between the outside polarizing plates.

The liquid crystal display panel 10 of this Comparison Configuration B is provided with the in-cell polarizing plate 50 on the color filter 28. The contrast of this in-cell polarizing plate 50 is 10, and the single transmittance is 45%.

Good black display cannot be achieved, and the contrast viewing angle also deteriorates if the in-cell polarizing plate 50 is simply added by itself without modifying the configuration of the viewing angle compensation film, such as the front-side TAC 44 or the rear-side biaxial film as in the case with the liquid crystal display panel 10 shown in Comparison Configuration B. An explanation is offered below using Poincare spheres.

Poincare Spheres

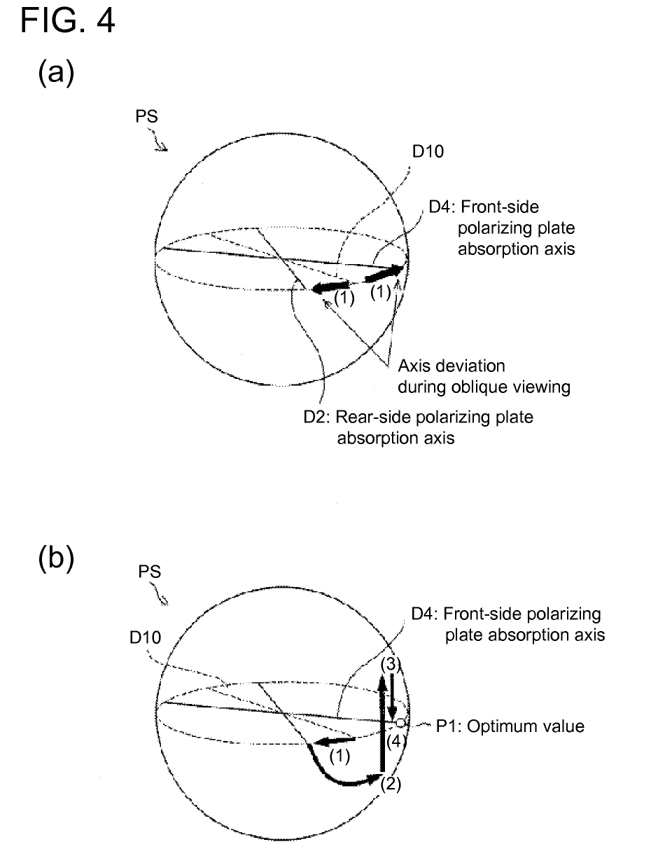

FIG. 4(a) is a diagram showing the position of the absorption axis of the polarizing plate on Poincare sphere PS.

Axis Deviation

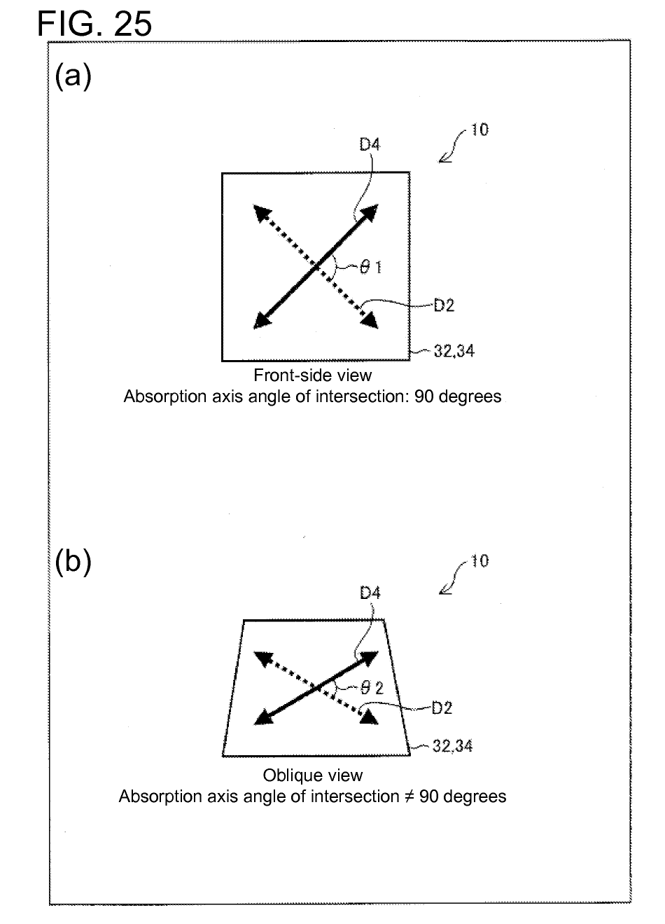

As shown in FIG. 25(b), when two polarizing plates with orthogonal absorption axes are viewed obliquely, the angle of intersection θ2 is no longer 90 degrees.

The axis deviation from the absorption axis D2 of the rear-side polarizing plate 32 and the absorption axis D4 of the front-side polarizing plate 34 when viewed from the absorption axis (D10) while viewing from the front is shown on the Poincare sphere PS in FIG. 4(a). In other words, the arrows (1) on the Poincare sphere PS indicate the axis deviation of the rear-side polarizing plate 32 and the axis deviation of the front-side polarizing plate 34.

Here, the effect of the axis deviation is eliminated by the viewing angle compensation film with the liquid crystal display panel 10 of Comparison Configuration A, making it possible to display high-quality black, even when viewing obliquely. An explanation is provided below, using FIG. 4(b).

Viewing Angle Compensation (Comparison Configuration A)

FIG. 4(b) is a diagram showing the viewing angle compensation in liquid crystal display panel 10 of Comparison Configuration A on Poincare sphere PS.

As shown in FIG. 4(b), in the liquid crystal display panel 10 of the Comparison Configuration A, there is polarization conversion through the rear-side biaxial film 52 or similar type of phase difference film (FIG. 4(b)-(2)), polarization conversion through the liquid crystal cell (VA) 20 (FIG. 4(b)-(3)), and polarization conversion through the front-side TAC 44 as a negative C plate (FIG. 4(b)-(4)), so that when light is emitted from the front-side polarizing plate 34, that light undergoes polarization conversions to the absorption axis (front-side polarizing plate absorption axis D4), which is in an axis deviation state (see FIG. 4 optimum value P1).

As described above, it is possible to realize high-quality black even for oblique viewing because the light entering the front-side polarizing plate 34 will be polarized along the absorption axis D4, which is in an axis deviation state.

When calculating the −C components for Comparison Configuration A, based on the rear-side biaxial film of −230 nm, the liquid crystal layer of 320 nm and the front-side TAC of be −55 nm, it yields 35 nm. Furthermore, because high-quality black display is obtained with the above configuration, the optimum −C component value for realizing a high-quality black display is considered to be 35 nm.

Optical Characteristics (Comparison Configuration A)

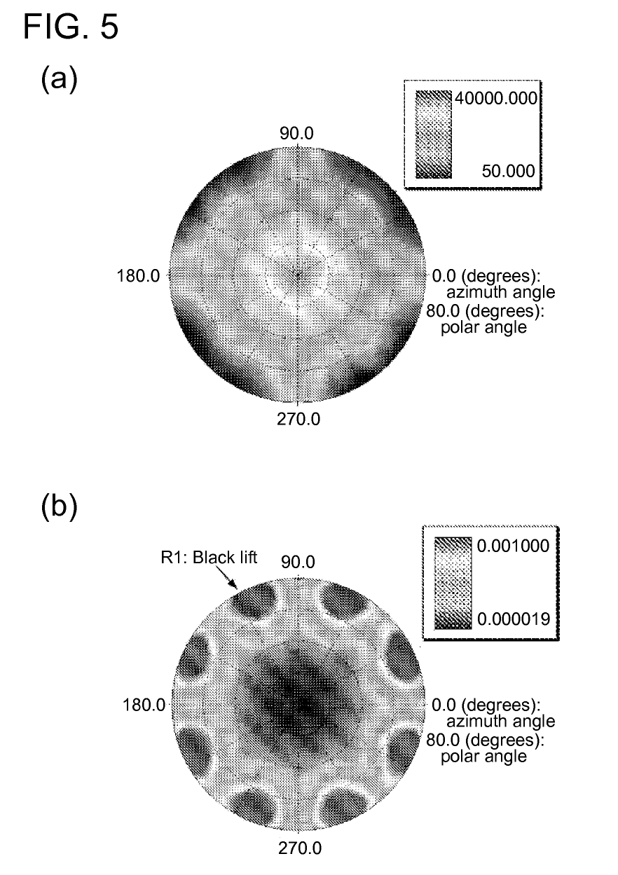

Below is provided an explanation of the optical characteristics of the liquid crystal display panel 10 of Comparison Configuration A using FIGS. 5(a) and 5(b). Here, FIG. 5(a) is a diagram showing an iso-contrast chart for the liquid crystal display panel 10 of the Comparison Configuration A and FIG. 5(b) is a diagram showing a black luminance chart for the liquid crystal display panel 10 of the Comparison Configuration A.

The term “azimuth” used in the diagrams means the rotation angle (the angle relative to 0 degrees) in the counterclockwise direction from the 0-degree position in a roughly rectangular liquid crystal display panel 10 forming the orthogonal coordinates system in the lengthwise direction and the transverse direction thereof.

The term “polar angle” means the angle of inclination from the direction normal to the surface of the liquid crystal display panel 10.

In each of the figures described above, the optical characteristics shown are the azimuth in a range of 0° to 360° and the polar angle from 0° to 80°.

As shown in FIG. 5(a), the liquid crystal display panel 10, which is not equipped with the in-cell polarizing plate 50, is equipped with the rear-side biaxial film 52 and front side TAC 42 so that excellent contrast with little viewing angle dependence can be achieved.

In other words, excellent viewing angle compensation is performed at L1 between the outside polarizing plates.

Additionally, as shown in FIG. 5(b), although the appearance of black lift (region R1 shown in FIG. 5(b)) was observed in all directions, the areas where it appeared were primarily the regions where the polar angle was 60° or higher.

Viewing Angle Compensation (Comparison Configuration B)

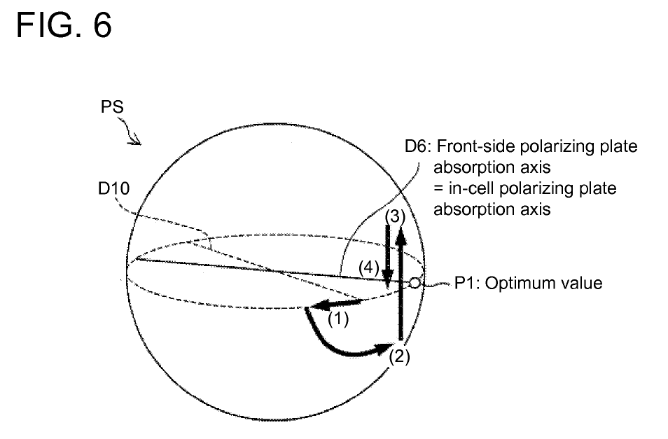

Next is provided an explanation of the viewing angle compensation on the liquid crystal display panel 10 of the Comparison Configuration B with reference to FIG. 6. Here, FIG. 6 is a diagram showing the viewing angle compensation on the liquid crystal display panel 10 of the Comparison Configuration B on the Poincare sphere PS.

As in the case with the liquid crystal display panel 10 of Comparison Configuration A, when the two polarizing plates with orthogonal absorption axes are viewed at an oblique angle, the angle of intersection θ2 is no longer 90° in the liquid crystal display panel 10 of Comparison Configuration B.

The axis deviation from the absorption axis (D10) when viewing the absorption axis D2 of the rear-side polarizing plate 32 and the absorption axis D4 of the front-side polarizing plate 34 from the front is indicated by the arrow (1) on the Poincare sphere PS shown in FIG. 6.

The light that passes through the rear-side polarizing plate 32 is first subjected to polarization conversion (FIG. 6-(2)) by a phase difference film such as the rear-side biaxial film 52 and subsequently is subjected to polarization conversion (FIG. 6-(3)) by the liquid crystal cell (VA) 20.

Here, in the liquid crystal display panel 10 of the Comparison Configuration B, before being subjected to polarization conversion by the front-side TAC 44, which functions as a −C plate, the light enters the in-cell polarizing plate 50, which functions as an analyzer. For that reason, the position of the light after the polarization conversion by liquid crystal cell 20 deviates from the absorption axis D6 of the in-cell polarizing plate 50 which is the optimum value P1.

For this reason, the liquid crystal display panel of the Comparison Configuration B cannot realize high-quality black display.

Also, the light that passes through the in-cell polarizing plate 50 is then subjected to polarization conversion (FIGS. 6-(4)) by the front-side TAC 44, which functions as a −C plate. However, as described above, it passes through the in-cell polarizing plate with the axis already deviated, so the light that goes through the polarization conversion through the front-side TAC 44 does not match the absorption axis D4 of the front-side polarizing plate 34.

As described above, high-quality black display cannot be realized with the liquid crystal display panel 10 of the Comparison Configuration B when viewing at an oblique angle.

Note also that the L2 negative C component between the rear-side polarizing plate and the in-cell polarizing plate in the Comparison Configuration B are: −230 nm at the rear-side biaxial film and 320 nm at the liquid crystal layer, so the total of the two is 90 nm.

Here, as described above, the optimum negative C component value for achieving high-quality black display is thought to be 35 nm.

For this reason, even considering the allowable range of retardation deviation (30 to 50 nm), the 90 nm value of the negative C component in the L2 between the rear-side polarizing plate and the in-cell polarizing plate exceeds an allowable range with respect to the optimum value (35 nm).

For that reason, it is considered that high-quality black display cannot be achieved on the liquid crystal display panel 10 of the Comparison Configuration B.

Optical Characteristics (Comparison Configuration B)

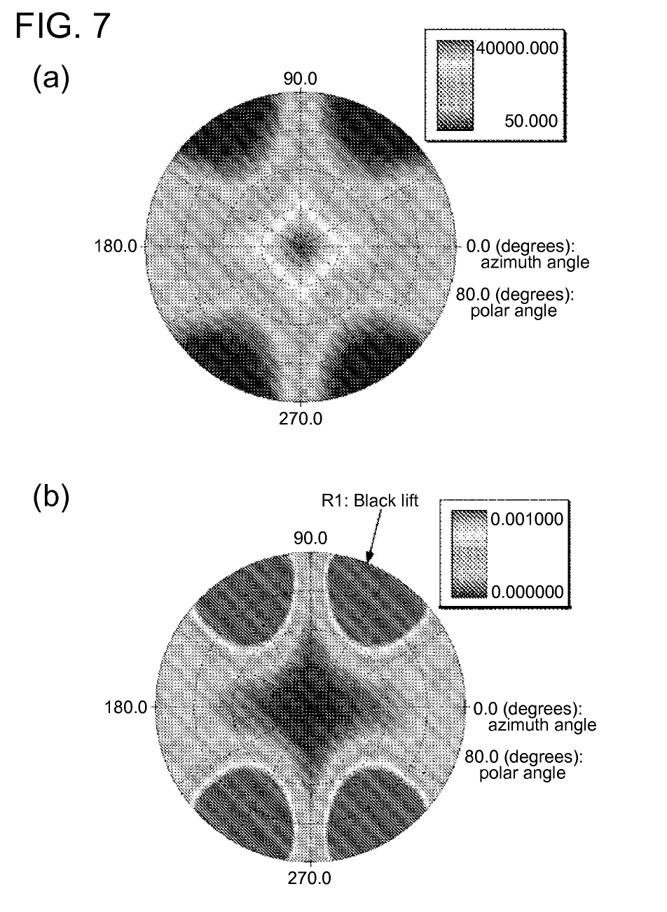

Next is provided an explanation of the optical characteristics of the liquid crystal display panel 10 of the Comparison Configuration B based on FIGS. 7(a) and 7(b). Here, FIG. 7(a) is a diagram showing an iso-contrast chart of the liquid crystal display panel 10 of the Comparison Configuration B and FIG. 7(b) is a diagram showing the black luminance chart for the liquid crystal display panel 10 of the Comparison Configuration B.

As shown in FIG. 7(a) above, the liquid crystal display panel 10, which has been provided the in-cell polarizing plate 50, viewing angle compensation will need to be performed at L2 between the rear-side polarizing plate and the in-cell polarizing plate, so that it will not be possible to achieve high-quality contrast with little viewing angle dependence with just the rear-side biaxial film in that space.

In other words, compared with FIG. 5(a) described above, with the liquid crystal display panel 10 of the Comparison Configuration B, the achievable iso-contrast range is small, as shown in FIG. 7(a). More specifically, there are regions in the vicinity of the 50° polar angle and beyond where the contrast differs considerably.

Also, as shown in FIG. 7(b), there was intense black lift (region R1 in FIG. 7(b)) with the liquid crystal display panel 10 of the Comparison Configuration B.

In other words, with the liquid crystal display panel 10 of the Comparison Configuration A, the black lift occurred primarily in a region where the polar angle was 60° or higher, as shown in FIG. 5(b). In contrast, with the liquid crystal display panel 10 of the Comparison Configuration B, black lift was observed in a region with a polar angle of 40° or more, as shown in FIG. 7(b).

### EMBODIMENT 1

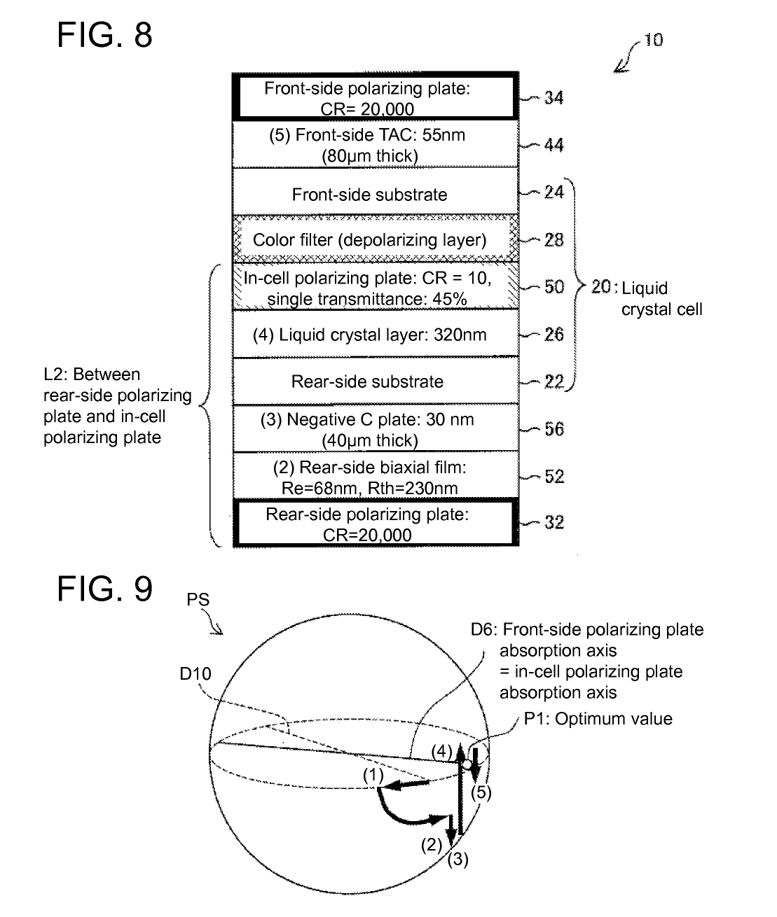

Therefore, Embodiment 1 of the liquid crystal display panel 10, shown in FIG. 8, is configured with a −C plate 56 between the liquid crystal layer 26 and the rear-side biaxial film 52 in order to optimize the viewing angle compensation at L2 between the rear-side polarizing plate and the in-cell polarizing plate.

FIG. 8 is a cross-section diagram showing a schematic of the layer configuration of the liquid crystal display panel 10 of this embodiment (Embodiment 1).

As shown in FIG. 8, the liquid crystal display panel 10 of Embodiment 1 is equipped with the negative C plate 56 between the rear-side polarizing plate 32 and the rear-side biaxial film 52 of the liquid crystal display panel 10 of the Comparison Configuration B, which was described earlier based on FIG. 3. Here, the “negative C plate 56” is a negative film, and a TAC film or equivalent with a retardation of 30 nm and a thickness of 40 um, for example, can be used therefor.

In other words, the liquid crystal display panel 10 of Embodiment 1 has a configuration with the negative C plate 56 at L2 between the rear-side polarizing plate and the in-cell polarizing plate in the liquid crystal display panel 10 shown in FIG. 1 in order to effect viewing angle compensation before the color filter 28.

What this does is to provide the rear-side biaxial film 52, the negative C plate 56 and the liquid crystal layer 26 at L2 in sequence between the rear-side polarizing plate and the in-cell polarizing plate.

The configuration of Embodiment 1 made it possible to effect viewing angle compensation that is equivalent to or better than the liquid crystal display panel 10 of Comparison Configuration A. An explanation is provided below.

Viewing Angle Compensation (Embodiment 1)

FIG. 9 is a diagram showing the viewing angle compensation of the liquid crystal display panel 10 of Embodiment 1 on the Poincare sphere PS.

The angle of intersection θ2 is also no longer 90° when the orthogonally-intersecting absorption axes of the two polarizing plates are viewed obliquely in the liquid crystal display panel 10 of Embodiment 1, as in the case of the liquid crystal display panel 10 of Comparison Configuration A.

The deviation of the absorption axis D2 of the rear-side polarizing plate 32 and the absorption axis D4 of the front-side polarizing plate 34 from the absorption axis (D10) when viewed from the front is shown by the arrow (1) on the Poincare sphere PS in FIG. 9.

The light that passes through the rear-side polarizing plate 32 is first subjected to polarization conversion (FIGS. 9-(2)) by the phase difference film, made of the rear-side biaxial film 52 or equivalent.

Here, in the liquid crystal display panel 10 of Embodiment 1, polarization conversion by the negative C plate 56 (FIGS. 9-(3)) occurs before polarization conversion (FIGS. 9-(4)) by the liquid crystal layer (VA) 20.

After this polarization conversion by the negative C plate 56, the light is subjected to polarization conversion (FIGS. 9-(4)) by the liquid crystal cell (VA) 20, and passes through the in-cell polarizing plate 50.

Here, with the liquid crystal display panel 10 of Embodiment 1, the light is subjected to polarization conversion by the negative C plate 56 before it enters the in-cell polarizing plate 50 so that the deviation from the optimum value of the optical axis is kept within an allowable range (30 to 50 nm) of deviation.

Next, the light that passes through the in-cell polarizing plate 50 is subjected to polarization conversion by the front-side TAC 44, which serves as the negative C plate 56 (FIG. 9-(4)). Then, the light that is emitted from the front-side TAC 44 enters the front-side polarizing plate 34.

Here, in the liquid crystal display panel 10 of Embodiment 1, the deviation from the optical axis of the front-side polarizing plate 34 and the optical axis of the light emitted from the front-side TAC 44 is kept within an allowable range of the optimum value (30 to 50 nm) as was the case with the optical axis deviation at the in-cell polarizing plate 50. For this reason, it was possible to display high-quality black.

In other words, compared with the viewing angle compensation using the liquid crystal display panel 10 of the Comparison Configuration B described previously using FIG. 6, with the liquid crystal display panel 10 of Embodiment 1, the polarization conversion using the negative C plate 56 is applied, so that the optical axis of the light after passing through the liquid crystal layer 26 approaches the optical axis of the in-cell polarizing plate 50.

Also, after passing through the front-side TAC 44, the light approaches the optimum value P1.

Therefore, it is possible to display high-quality black using the liquid crystal display panel 10 of Embodiment 1.

The term “optimum value” of the phase difference in the viewing angle compensation refers to the value of the phase difference in the thickness direction of the liquid crystal layer and the value of the in-plane phase difference between the first polarizing plate and the second polarizing plate, such that the polarized light that enters from the polarizer is changed to a polarized state that matches the absorption axis of the analyzer immediately before entering the analyzer.

In the liquid crystal display panel 10 of this embodiment, which is provided with the rear-side polarizing plate (first polarizing plate) 32, the front-side polarizing plate (second polarizing plate) 34, and the in-cell polarizing plate 50, the rear-side polarizing plate 32 becomes a polarizer and the in-cell polarizing plate 50 becomes an analyzer 1, serving as the first analyzer and the front-side polarizing plate 34 becomes analyzer 2, serving as the second analyzer.

Optical Characteristics (Embodiment 1)

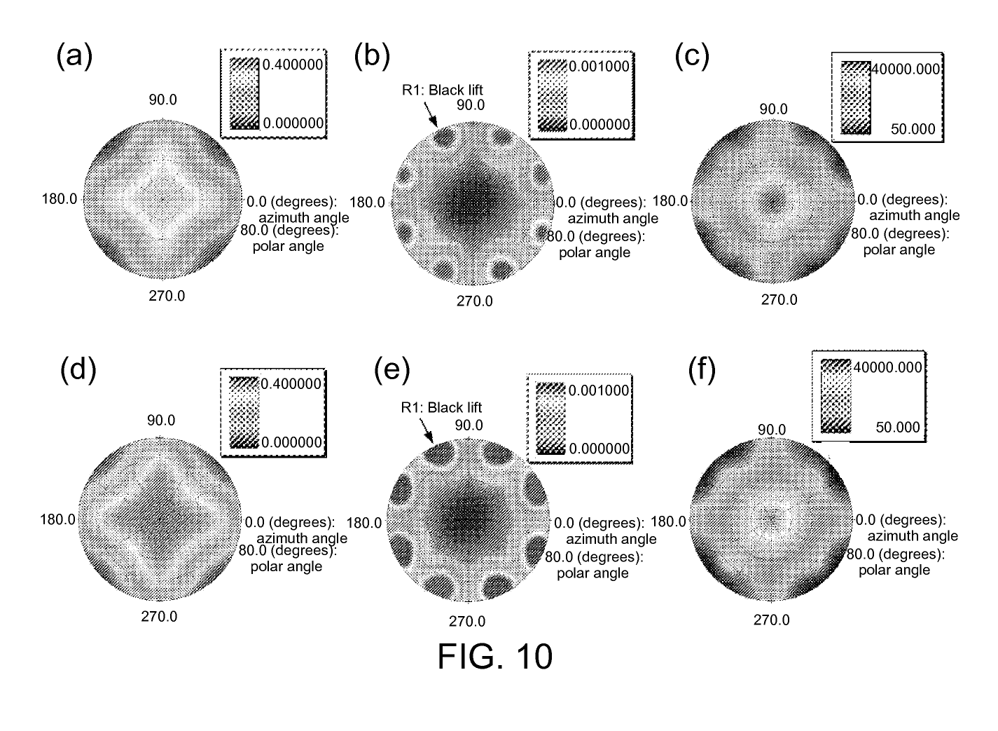

Below is provided an explanation of the optical characteristics of the liquid crystal display panel 10 of Embodiment 1 with reference to FIGS. 10(a) to 10(f) while drawing comparison to the optical characteristics of the liquid crystal display panel 10 of the Comparison Configuration A.

Here, FIGS. 10(a) to 10(c) show the optical characteristics of the liquid crystal display panel 10 of Embodiment 1 and FIGS. 10(d) to 10(f) show the optical characteristics of the liquid crystal display panel 10 of the Comparison Configuration A.

FIGS. 10(a) and 10(d) show white luminance charts, FIGS. 10(b) and 10(e) show black luminance charts, and FIGS. 10(c) and 10(f) show iso-contrast charts.

First, as shown in FIGS. 10(a) and 10(d), with the liquid crystal display panel 10 of Embodiment 1, white luminance that is roughly equivalent to that of the liquid crystal display panel 10 of Comparison Configuration A has been achieved (Ref (Comparison Configuration A) ratio: 85.6%).

As shown in FIGS. 10(b) and 10(e), for black luminance (the occurrence of black lift), the liquid crystal display panel 10 of Embodiment 1 exhibited better results than the liquid crystal display panel 10 of the Comparison Configuration A. In other words, when comparing the liquid crystal display panel 10 of Embodiment 1 with the liquid crystal display panel 10 of the Comparison Configuration A, if we compare the region where the black lift (R1) occurs, it is clear that the black lift region has been reduced by the liquid crystal display panel 10 of Embodiment 1.

With respect to the contrast shown in FIGS. 10(c) and 10(f), the liquid crystal display panel 10 of Embodiment 1 had contrast of 35900, a level that is 186% of the Ref (Comparison Configuration A).

### Summary

As described above, by performing the optical compensation (Rth Total =(optimum value −30 nm)) by adding a phase difference plate, which is the addition of the TAC layer as a negative C component, for example, to a layer of biaxial film, the liquid crystal display panel 10 equipped with the in-cell polarizing plate 50 can achieve viewing angle compensation that is equivalent to or better than that of the current liquid crystal display panel 10 that is not provided the in-cell polarizing plate 50.

In the configuration described above, the material used for the optical compensation is TAC, which is an existing material. Therefore, cost increase is suppressed.

Thickness of Negative C

Here, the explanation above is based on the configuration in which material with a retardation of 30 nm (thickness of 40 nm) is used as the negative C plate 56.

The retardation of the negative C plate 56 is not particularly limited to 30 nm, and it is possible to change it as appropriate, depending upon the design of the liquid crystal display panel.

However, in the liquid crystal display panel of Embodiment 1 shown in FIG. 8, it is preferable that a retardation be −30 nm for the negative C plate 56.

That is, with the liquid crystal display panel of Embodiment 1, the negative C component at L2 between the rear-side polarizing plate and the in-cell polarizing plate is: −230 nm for the rear-side biaxial film, −30 for the negative C plate and 320 for the liquid crystal layer, resulting in a total of 60 nm.

And, this value is within the allowable range (30 to 50 nm) from the optimum value (35 nm) described above.

Also, with the liquid crystal display panel 10 of Embodiment 1, the negative C component at L1 between the outside polarizing plates is: −230 nm for the rear-side biaxial film, −30 for the negative C plate, 320 nm for the liquid crystal layer and −55 nm for the rear-side TAC, resulting in a total of 5 nm.

This value is within the allowable range (30 to 50 nm) from the optimum value (35 nm) described above. In other words, the total of the Rth is compensated to −30 nm from the optimum value.

As described above, in Embodiment 1, although the negative C components deviate from the optimum value, they are kept within an allowable range for both the L1 between the outside polarizing plates and L2 between the rear-side polarizing plate and the in-cell polarizing plate.

For this reason, a high-quality black display is achieved.

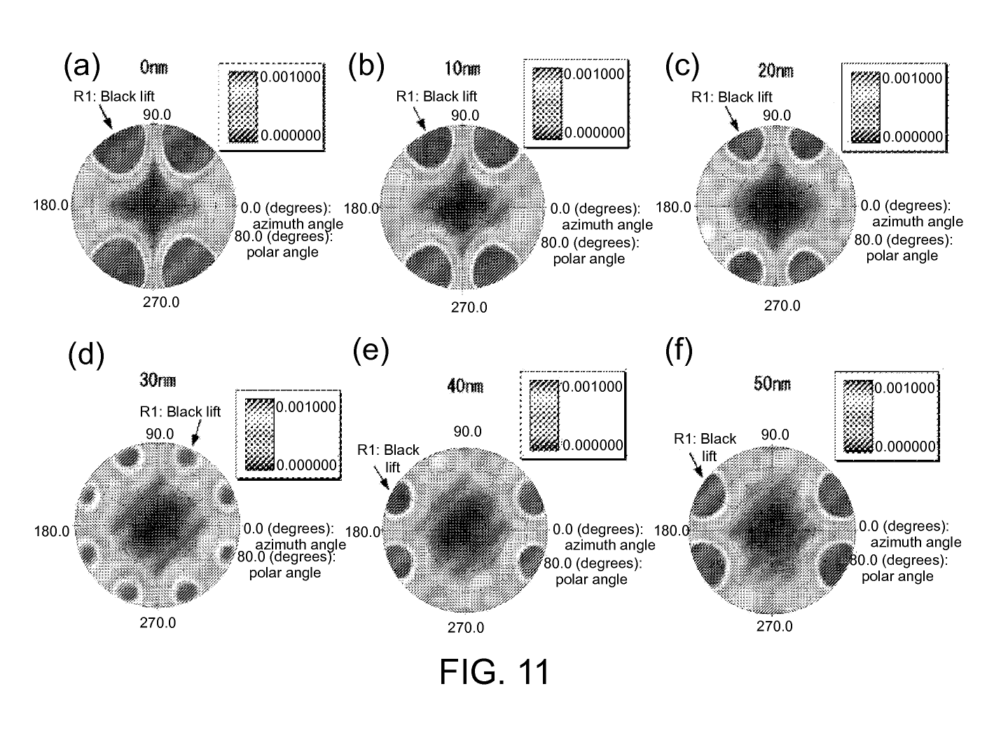

Now, referring to FIGS. 11(a) to 11(f), we will explain the black luminance when varying the thickness to the negative C plate 56 (retardation), without making any other changes to the configuration of Embodiment 1. FIGS. 11(a) to 11(f) show the black luminance charts of the liquid crystal display panel 10 when the negative C plate 56 thickness is varied. FIGS. 11(a) to 11(f) show progressively greater values in the negative C plate 56 retardation, with 0 nm, 10 nm, 20 nm, 30 nm, 40 nm and 50 nm, respectively.

As shown in FIG. 11(d), the viewing angle dependence of the black lift is smallest when the retardation of the negative C plate 56 is 30 nm, and that makes it possible to achieve an optimum black display.

### EMBODIMENT 2

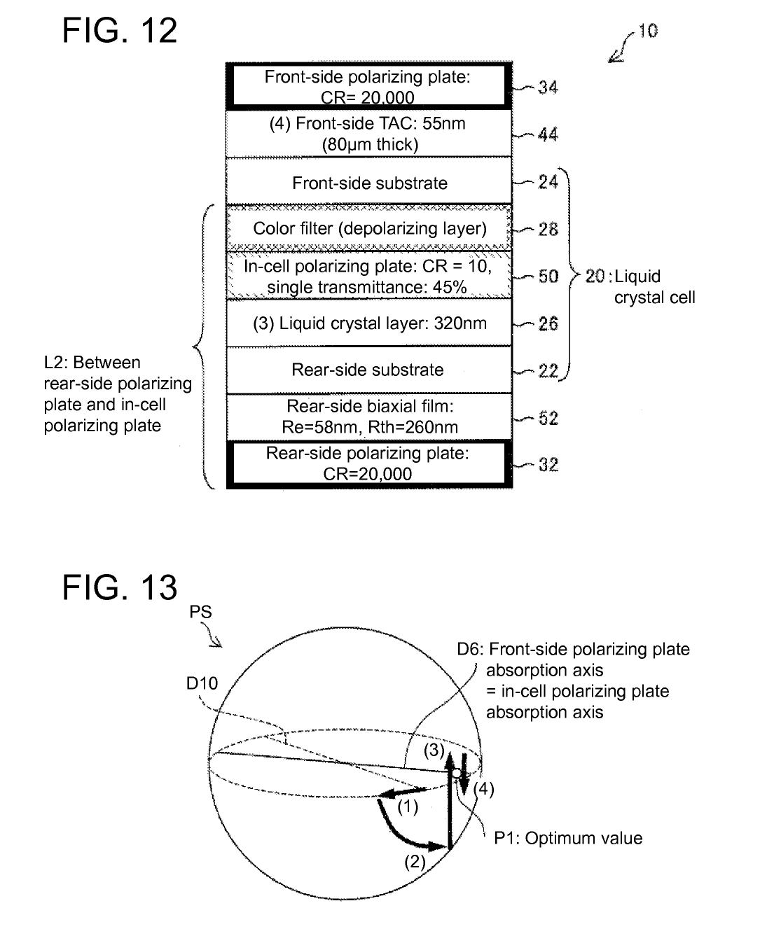

The explanation of another embodiment of the present invention is provided with reference to FIGS. 12 to 15. Note that configurations other than those described in this embodiment are the same configurations as described in Embodiment 1 described above. In addition, for ease of explanation, we have appended the same symbols to the members of this embodiment that have the same function as the members of FIG. 10 of the configuration described above and will forego repeated explanation therefor.

Unlike the liquid crystal display panel 10 of Embodiment 1, the liquid crystal display panel 10 of this embodiment is provided with just one layer of a viewing angle compensation film in L2 between the rear-side polarizing plate and the in-cell polarizing plate.

That is, as shown in FIG. 8, L2 between the rear-side polarizing plate and the in-cell polarizing plate in the liquid crystal display panel 10 of Embodiment 1 configuration of Embodiment 1 was provided with two layers of viewing angle compensation film: the rear-side biaxial film 52 and the negative C plate 56.

In contrast, L2 between the rear-side polarizing plate and the in-cell polarizing plate in the liquid crystal display panel 10 of Embodiment 2 in the present embodiment is provided with only one layer of a viewing angle compensation film: the rear-side biaxial film 52. This will be explained below.

FIG. 12 is a cross-section diagram showing a schematic of the layer configuration of the liquid crystal display panel 10 of Embodiment 2. As shown in FIG. 12, the liquid crystal display panel 10 of Embodiment 2 has essentially the same configuration as the liquid crystal display panel 10 of the Comparison Configuration B described previously based on FIG. 3.

However, the retardation of the rear-side biaxial film 52 is different. That is, in the Comparison Configuration B, for the rear-side biaxial film 52, the retardation was Re=68 nm, Rth=230 nm while the rear-side biaxial film 52 of Embodiment 2 has Re=58 nm and Rth=260 nm.

In other words, for the liquid crystal display panel 10 having the in-cell polarizing plate 50, an optimized biaxial film is newly designed and used as the rear-side biaxial film 52.

And, by using aforementioned Embodiment 2, it was possible to realize viewing angle compensation that was equivalent to that of the liquid crystal display panel 10 of Embodiment 1. An explanation is provided below.

Viewing Angle Compensation (Embodiment 2)

FIG. 13 is a diagram that shows the viewing angle compensation of the liquid crystal display panel 10 of Embodiment 2 on the Poincare sphere PS.

As with the liquid crystal display panel 10 of Embodiment 1, the angle of intersection θ2 is no longer 90° when the two polarizing plates with orthogonal absorption axes were viewed at an oblique angle in the liquid crystal display panel 10 of Embodiment 2.

The arrow (1) on the Poincare sphere PS in FIG. 13 shows the axis deviation of the absorption axis D2 of the rear-side polarizing plate 32 and of the absorption axis D4 of the front-side polarizing plate 34 from the absorption axis (D10) when viewing from the front.

The light that passes through the rear-side polarizing plate 32 is first subject to polarization conversion (FIGS. 13-(2)) by a phase difference film such as the rear-side biaxial film 52.

After undergoing the polarization conversion through the phase difference film, the light is subject to the polarization conversion (FIGS. 13-(3)) by the liquid crystal cell (VA) 20, and thereafter passes through the in-cell polarizing plate 50.

Here, the retardation of the rear-side biaxial film 52 has been optimized for the liquid crystal display panel 10 of Embodiment 2. In other words, as described above, Re=58 nm and Rth=260 nm.

Because of this, in the liquid crystal display panel 10 of Embodiment 2, the negative C component at L2 between the rear-side polarizing plate and the in-cell polarizing plate is: −260 nm for the rear-side biaxial film and 320 nm for the liquid crystal layer, resulting in a total of 60 nm.

This value falls within the allowable range (30 to 50 nm) from the optimum level (35 nm) described earlier.

Here, in the configuration with one layer of rear-side biaxial film 52, the optimum value for the phase difference are: the residual phase difference values between the polarizer and the analyzer being Re=55 to 75 nm and Rth=35 nm (when using the TAC as the protective film of the front-side polarizing plate 34 (Rth=−55 (−50 to −60 nm)) and setting the phase difference for the liquid crystal layer 26 to Rth=320 nm). Here, the Re indicates the in-plane phase difference and, as described earlier, and Rth indicates the phase difference in the thickness direction. And, both the in-plane phase difference (Re) and the phase difference in the thickness direction (Rth) contribute to the polarization conversion using the biaxial film.

Next, the light passing through the in-cell polarizing plate is subjected to a polarization conversion through the front-side TAC 44 as the negative C plate (FIGS. 13-(4)). Then, the light emitted from the front-side TAC 44 enters the front-side polarizing plate 34.

Here, in the liquid crystal display panel 10 of Embodiment 2, the negative C component at L1 between the outside polarizing plates is: rear-side biaxial film=−260 nm, liquid crystal layer=320 nm, front-side TAC=−55 nm, resulting in a total of 5 nm.

This value falls within the allowable range (30 to 50 nm) from the optimum value (35 nm) described earlier. In other words, the total Rth is compensated to −30 nm from the optimum value.

As described above, in Embodiment 2, as in the case for Embodiment 1, the optimum negative C component values are slightly off for both L2 between the rear-side polarizing plate and the in-cell polarizing plate and L1 outside polarizing plates; but they are within the allowable range.

Therefore, a high-quality black display can be achieved with the liquid crystal display panel 10 of Embodiment 2.

Optical Characteristics (Embodiment 2)

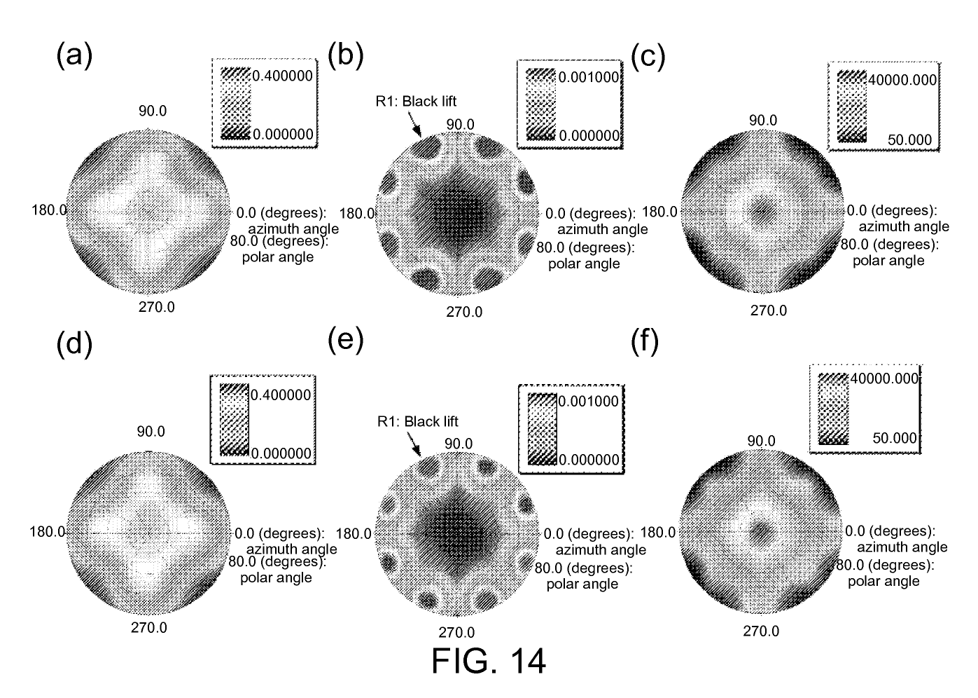

Below is provided an explanation of the optical characteristics of the liquid crystal display panel 10 of Embodiment 1 with reference to FIGS. 14(a) to 14(f) while drawing comparisons to the liquid crystal display panel 10 of Embodiment 1.

Here, FIGS. 14(a) to 14(c) show the optical characteristics of the liquid crystal display panel 10 of Embodiment 2 and FIGS. 14(d) to 14(f) show the optical characteristics of the liquid crystal display panel 10 of Embodiment 1.

FIGS. 14(a) and 14(d) show the white luminance charts, FIGS. 14(b) and 14(e) show the black luminance charts, and FIGS. 14(c) and 14(f) show the iso-contrast charts.

First, as shown in FIGS. 14(a) and 14(d), the white luminance of the liquid crystal display panel 10 of Embodiment 2 is nearly equivalent to that of liquid crystal display panel 10 of Embodiment 1 (Ref (Comparison Configuration A) ratio: 85.6%).

As shown in FIGS. 14(b) and 14(e), in terms of black luminance (occurrence of black lift), the results with the liquid crystal display panel 10 of Embodiment 2 are nearly equivalent to those with the liquid crystal display panel 10 of Embodiment 2. That is, when comparing the liquid crystal display panel 10 of Embodiment 2 with the liquid crystal display 10 of Embodiment 2, the size of the region where the black lift (R1) occurs is slightly larger in the liquid crystal display panel 10 of Embodiment 2, but it is a level that should not cause problems.

Regarding the contrast shown in FIGS. 14(c) and 14(f), the liquid crystal display panel 10 of Embodiment 2 exhibits nearly equivalent contrast to that of the liquid crystal display panel 10 of Embodiment 1. That contrast is 35900 and the Ref (Comparison Configuration A) ratio for this value is 186%.

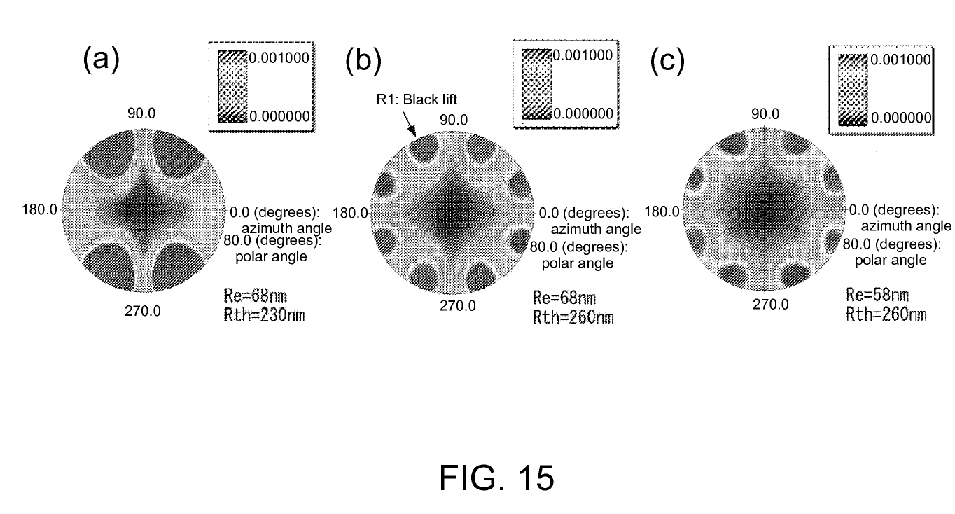

Here, an explanation will be provided, referring to FIGS. 15(a) to 15(c), for the black luminance of Embodiment 2 when the rear-side biaxial film retardation is varied without changing any other structures. FIGS. 15(a) to 15(c) show the black luminance charts of the liquid crystal display panel 10 when varying only the rear-side biaxial film 52 retardation.

More specifically, FIG. 15(a) shows the black luminance chart for the case of the rear-side biaxial film 52 retardation being Re=68 nm and Rth=230 nm (that is, Comparison Configuration B); FIG. 15(b) shows the black luminance chart for the case of the rear-side biaxial film 52 retardation being Re=68 nm and Rth=260 nm; and FIG. 15(c) shows the case of the rear-side biaxial film 52 retardation being Re=58 nm and Rth=260 nm, that is, the black luminance chart for Embodiment 2.

As shown in FIG. 15(c), when the rear-side biaxial film 52 retardation is Re=58 nm, Rth=260 nm, the viewing angle dependence of the black lift is at its smallest. Thus, an optimum black display was achieved.

### EMBODIMENT 3

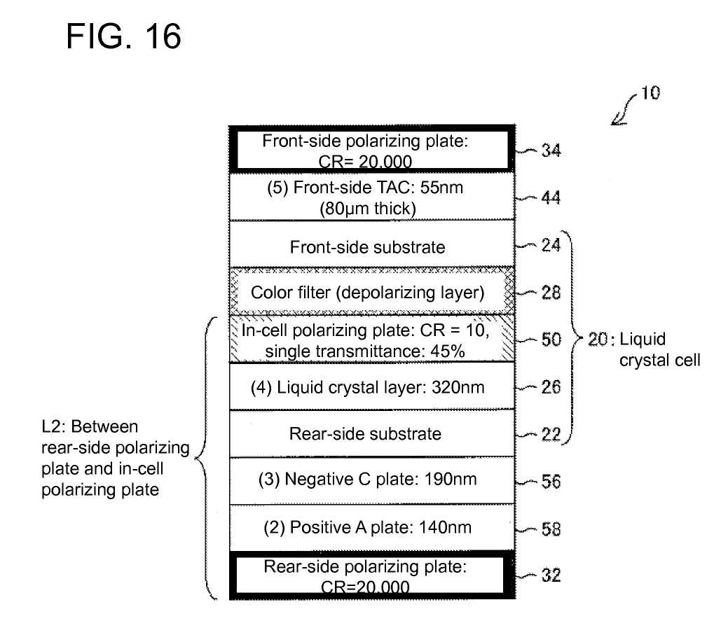

Below is provided an explanation of another embodiment of the present invention with reference to FIGS. 16 to 19. Structures other than those explained in this embodiment are the same as those in the embodiments described above. For ease of explanation, the same symbols are appended to the members of this embodiment that have the same function as the members of the embodiments described above and will forego repeated explanation therefor.

Unlike the liquid crystal display panel 10 of Embodiment 2 configuration that was described in Embodiment 2 above, the liquid crystal display panel 10 of this embodiment was provided with a positive A plate 58 and a negative C plate 56 in L2 between the rear-side polarizing plate and the in-cell polarizing plate.

In the liquid crystal display panel 10 of Embodiment 2 that was described earlier with reference to FIG. 12, in L2 between the rear-side polarizing plate and the in-cell polarizing plate, only the rear-side biaxial film 52 was provided as the viewing angle compensation film.

In contrast, in the liquid crystal display panel 10 of Embodiment 3, which shows an example of the configuration used in the liquid crystal display panel 10 of the present embodiment, the positive A plate 58 and the negative C plate 56 are provided as the viewing angle compensation film in L2 between the rear-side polarizing plate and the in-cell polarizing plate, as shown in FIG. 16. Here, FIG. 16 is a cross-section diagram showing a schematic of the layer configuration of the liquid crystal display panel of Embodiment 3.

More specifically, as shown in FIG. 16, the negative C plate 56 and the positive A plate 58 are layered in that order on the surface opposite the surface facing the liquid crystal layer 26 of the rear-side substrate 22. In this example of Embodiment 3, the retardation of the negative C plate 56 is −190 nm, and the retardation of the positive A plate 58 is 140 nm.

Also, in the same manner as the liquid crystal display panel 10 of Embodiment 2 that was described earlier based on FIG. 12, the front-side TAC 44 with a retardation of 55 nm was provided between the in-cell polarizing plate 50 and the front-side polarizing plate 34.

This liquid crystal display panel 10 of Embodiment 2 can provide very high-quality viewing angle compensation (for example, equivalent to the liquid crystal display panel 10 not provided with the in-cell polarizing plate 50) possible. An explanation is provided below.

Comparison Configuration C

First, for comparison, an example of the liquid crystal display panel 10 not provided with the in-cell polarizing plate 50 will be explained below.

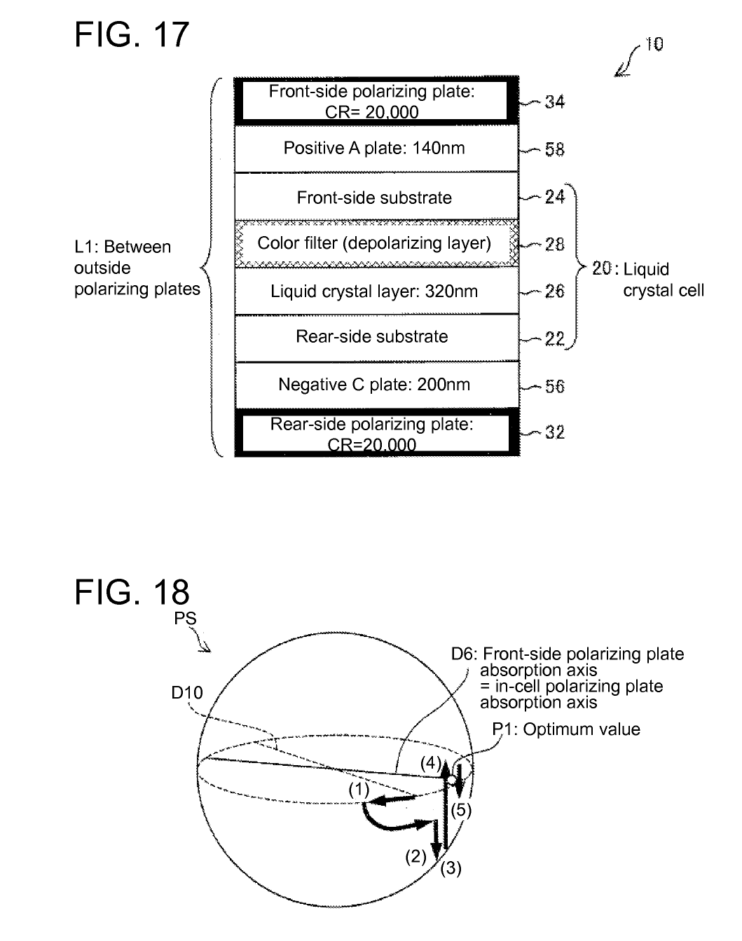

As a configuration that would perform viewing angle compensation using a film for viewing angle compensation in a liquid crystal display panel 10 that is not provided with the in-cell polarizing plate 50, a configuration in which a negative C plate 56 and a positive A plate 58 are provided in L1 between the outside polarizing plates is conceivable (Comparison Configuration C). FIG. 17 is a cross-section diagram showing a schematic of the layer configuration of a liquid crystal display panel 10 of Comparison Configuration C.

As shown in FIG. 17, the liquid crystal display panel 10 in Comparison Configuration C is only provided with the rear-side polarizing plate 32 and the front-side polarizing plate 34 as polarizing plates and is not provided with the in-cell polarizing plate 50.

As viewing angle compensation films, a negative C plate 56 is provided between the rear-side substrate 22 and the rear-side polarizing plate 32, and the positive A plate 58 is provided between the front-side substrate 24 and the front-side polarizing plate 34. Here, in the Comparison Configuration C, the negative C plate 56 has a retardation of 200 nm, and the positive A plate 58 has a retardation of 140 nm.

As in all of the configurations previously described, the liquid crystal layer is formed of liquid crystal with a Δn of 0.1, and its retardation is 320 nm.

With the Comparison Configuration C described above, the occurrence of black lift was suppressed, so that high-quality black display is possible even in oblique viewing.

Here, the negative C component in the Comparison Configuration C is: 200 nm for the negative C plate 56, 320 nm for the liquid crystal layer 26, resulting in a total of 120 nm. In other words, in order to accomplish high-quality viewing angle compensation with this configuration, the optimum Rth value is 120 nm.

### EMBODIMENT 3

Next, we will explain Embodiment 3, which is an example of a configuration for this embodiment.

Embodiment 3 has a configuration that performs the viewing angle compensation in L1 between the outside polarizing plates for the liquid crystal display panel 10 not provided with the in-cell polarizing plate 50 (Comparison Configuration C) at the rear side of the liquid crystal display panel 10.

Because the liquid crystal display panel 10 of Embodiment 3 is provided with the in-cell polarizing plate 50, the viewing angle compensation must be performed adequately at L2 between the rear-side polarizing plate and the in-cell polarizing plate.

For that reason, the positive A plate 58 and the negative C plate 56 were both provided in L2 between the rear-side polarizing plate and the in-cell polarizing plate. And, the negative C plate retardation is optimized, resulting a retardation value of −190 nm, as stated above.

Here, the negative C component of L2 between the rear-side polarizing plate and in-cell polarizing plate in the liquid crystal display panel 10 of Embodiment 3 is: a negative C plate =−190 nm, a liquid crystal layer=320 nm, resulting in a total of 130 nm.

This value is within the allowable range (30 to 50 nm) from the optimum value (120 nm).

Here, with the configuration that uses the positive A plate 58 and the negative C plate 56 described above, for the optimum phase difference value, the residual phase difference value between the polarizer and the analyzer is: Re=130 to 150 nm and Rth=120 nm (when a TAC (Rth=−55 nm (50 to 60 nm)) is used as a protective film for the front-side polarizing plate 34, and the phase difference value Rth of the liquid crystal layer 26 is 320 nm.)

In the liquid crystal display panel 10 of Embodiment 3, the negative C component of L1 between the outside polarizing plates is: a negative C plate of −190 nm, a liquid crystal layer of 320 nm, and a front-side TAC of −55 nm, resulting in a total of 75 nm.

This value falls within the allowable range (30 to 50 nm) from the optimum value (35nm) described above. In other words, the total value of Rth is compensated to −45 nm from the optimum value.

As described above, in Embodiment 3, although the negative C components deviate from the optimum values at both L2 between the rear-side polarizing plate and the in-cell polarizing plate and L1 between the outside polarizing plates, they fall within the allowable ranges.

Viewing Angle Compensation (Embodiment 3)

Next is provided an explanation of the viewing angle compensation for the liquid crystal display panel 10 of Embodiment 3 using the Poincare sphere PS.

FIG. 18 is a diagram that shows the viewing angle compensation for the liquid crystal display panel 10 of Embodiment 1 on the Poincare sphere PS.

In the liquid crystal display panel 10 of Embodiment 3, the angle of intersection θ2 is no longer 90° when the two polarizing plates with their absorption axes arranged orthogonally are viewed at an oblique angle.

The arrow (1) on the Poincare sphere PS in FIG. 18 shows the axis deviation from the absorption axis (D10) when the absorption axis D2 of this rear-side polarizing plate 32 and the absorption axis D4 of the front-side polarizing plate 34 are viewed from the front.

The light that passes through the rear-side polarizing plate 32 first undergoes polarization conversion (FIGS. 18-(2)) through a phase difference film, such as the positive A plate 58.

In the liquid crystal display panel 10 of Embodiment 3, the light is subjected to polarization conversion (FIGS. 18-(3)) through negative C plate 56 before being subjected to polarization conversion (FIGS. 18-(4)) through the liquid crystal cell (VA) 20.

After undergoing polarization conversion through negative C plate 56, the light is subjected to polarization conversion (FIGS. 18-(4)) through the liquid crystal cell (VA) 20, and passes through the in-cell polarizing plate 50.

Here, in the liquid crystal display panel 10 of Embodiment 1, before the light can enter the in-cell polarizing plate 50, it is subjected to polarization conversion by the negative C plate 56, whose retardation has been optimized, so that the deviation from the optimum value of the optical axis falls within the allowable range (30 to 50 nm).

Next, the light that passes through the in-cell polarizing plate 50 is subjected to polarization conversion by the front-side TAC 44, which acts as a negative C plate (FIGS. 18-(4)). Next, the light emitted from the front-side TAC44 enters the front-side polarizing plate 34.

Here, in the liquid crystal display panel 10 of the Embodiment 3, similar to the optical axis deviation at the in-cell polarizing plate described above, the deviation between the optical axis of the light emitted from the front-side TAC 44 and the optical axis of the front-side polarizing plate falls within the allowable range (30 to 50 nm) form the optimum value. For this reason, it was possible to achieve a high-quality black display.

Optical Characteristics (Embodiment 3)

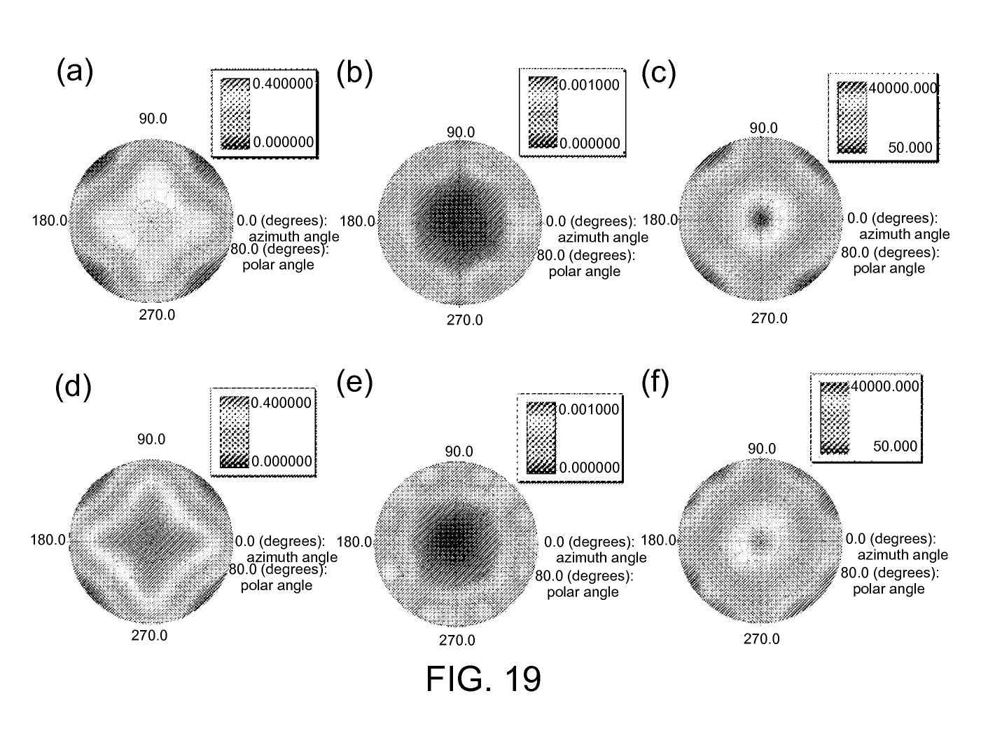

Below, we will explain the optical characteristics of the liquid crystal display panel 10 of Embodiment 3 based on FIGS. 19(a) to 19(f) while drawing comparisons to the optical characteristics of the liquid crystal display panel 10 of Comparison Configuration C.

Here, FIGS. 19(a) to 19(c) show the optical characteristics of the liquid crystal display panel 10 of Embodiment 3 and FIGS. 19(d) to 19(f) show the optical characteristics of the liquid crystal display panel 10 of Comparison Configuration C.

FIGS. 19(a) and 19(d) show white luminance charts, FIGS. 19(b) and 19(e) show black luminance charts, and FIGS. 19(c) and 19(f) show iso-contrast charts.

First, as shown in FIGS. 19(a) and 19(d), in the liquid crystal display panel 10 of Embodiment 3, it was possible to realize white luminance that was nearly equivalent to that of the liquid crystal display panel 10 of Comparison Configuration 1 (Ref (Comparison Configuration A) ratio of 85.6%).

As shown in FIGS. 19(b) and 19(e), for the black luminance (black lift occurrence), the liquid crystal display panel 10 of Embodiment 3 exhibited results that were nearly equivalent to those of the liquid crystal display panel 10 of Comparison Configuration C.

In other words, when viewed obliquely, black lift occurrence is suppressed to such a degree that black lift becomes almost unnoticeable.

For the contrast shown in FIGS. 19(c) and 19(f), the liquid crystal display panel 10 of Embodiment 3 displayed contrast that was nearly equivalent to that of the liquid crystal display panel 10 of Embodiment 1. That contrast was 35900 and the value was 186% of the Ref ratio (Comparison Configuration A).

Other Configuration Examples

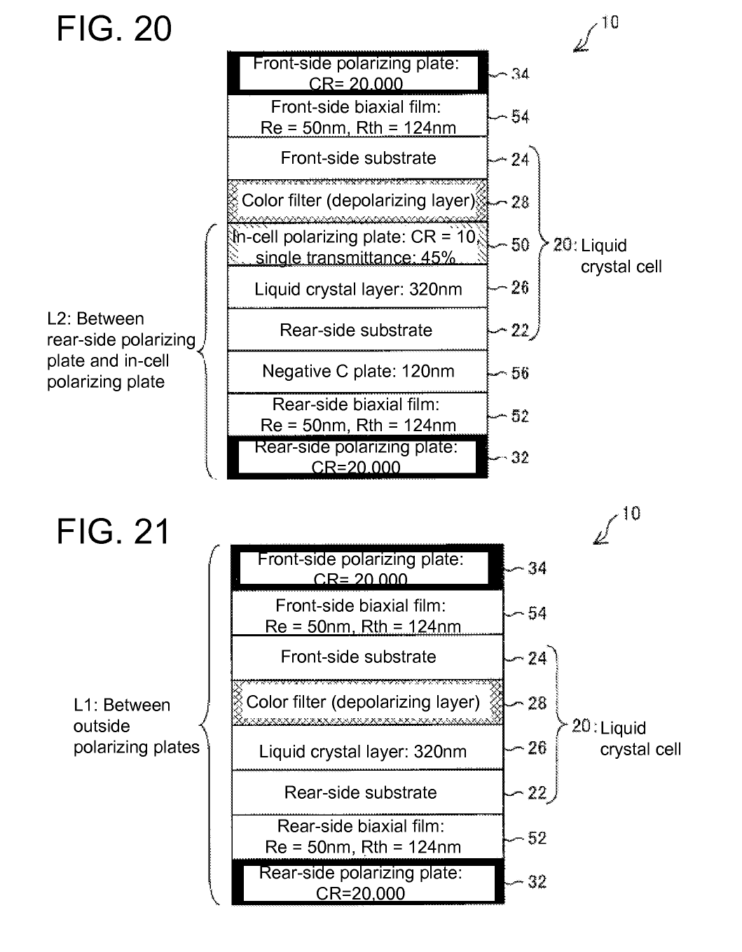

Next, other configurations for the liquid crystal display panel 10 will be analyzed with reference to FIGS. 20 to 22. Structures other than those explained herein are the same as those of the embodiments described above. Additionally, for ease of explanation, we have appended the same symbols to the members of this embodiment that have the same function as the members of each of the preceding embodiments and we will forego repeated explanations therefor.

Comparison Configuration E

FIG. 20 is a cross-section diagram showing a schematic of the layer configuration of a liquid crystal display panel 10 of Comparison Configuration E.

One feature that the liquid crystal display panel 10 of Comparison Configuration E has when compared with the liquid crystal display panel 10 of Embodiment 1 configuration, which was described in Embodiment 1 based on FIG. 8, is that a front-side biaxial film 54 is provided in place of the front-side TAC 44. Also, the rear-side biaxial film 52 and the negative C plate 56 in the liquid crystal display panel 10 of Embodiment 1 differ from those of the rear-side biaxial film 52 and the negative C plate 56 of the liquid crystal display panel 10 of Embodiment 4 in their retardations. A more specific explanation is provided below.

As shown in FIG. 20 above, in the liquid crystal display panel 10 of Comparison Configuration E, the rear-side biaxial film 52 and negative C plate 56 are provided as the viewing angle compensation film in L2 between the rear-side polarizing plate and in-cell polarizing plate. More specifically, as shown in FIG. 20 above, the rear-side biaxial film 52 and the negative C plate 56 are layered in that order on the surface that opposes the surface facing the liquid crystal layer 26 of the rear-side substrate 22. In this Comparison Configuration E, the retardation of the rear-side biaxial film 52 is Re=50 nm and Rth=124 nm.

It can be said that this Comparison Configuration E applies an optical compensation using two layers of biaxial film, which is normally performed for a liquid crystal display panel 10 not provided with the in-cell polarizing plate 50, to the liquid crystal display panel 10 equipped with the in-cell polarizing plate 50. Below is provided an explanation while drawing comparisons with the liquid crystal display panel 10 not provided with the in-cell polarizing plate 50.

Comparison Configuration D

FIG. 21 is a cross-section diagram showing a schematic of the layer configuration of a liquid crystal display panel 10 of Comparison Configuration D.

In the liquid crystal display panel 10 of Comparison Configuration D shown in FIG. 21, no in-cell polarizing plate 50 is provided and the viewing angle compensation is performed by providing two layers of biaxial film in L1 between the outside polarizing plates.

More specifically, the liquid crystal display panel 10 of Comparison Configuration D is not provided with the in-cell polarizing plate 50, but is only provided with the rear-side polarizing plate 32 and the front-side polarizing plate 34 as polarizing plates.

As the films for viewing angle compensation, a rear-side biaxial film 52 is provided between the rear-side substrate 22 and the rear-side polarizing plate 32, and a front-side biaxial film 54 is provided between the front-side substrate 24 and the front-side polarizing plate 34.

Here, in Comparison Configuration D, the rear-side biaxial film 52 and the front-side biaxial film 54 both have an Re of 50 nm and an Rth of 124 nm.

High-quality viewing angle compensation is achieved on the liquid crystal display panel 10 of Comparison Configuration D. In other words, the two layers of biaxial film described above achieve viewing angle compensation in L1 between the outside polarizing plates.

Comparison Configuration E is a configuration example in which this viewing angle compensation using two layers of the biaxial film is applied to the liquid crystal display panel 10 equipped with the in-cell polarizing plate 50.

Because Comparison Configuration E is provided with the in-cell polarizing plate 50, it is necessary to consider viewing angle compensation in L2 between the rear-side polarizing plate and the in-cell polarizing plate. In order to optimize the viewing angle compensation at L2 between the rear-side polarizing plate and the in-cell polarizing plate, the negative C plate 56 is added to L2 between the rear-side polarizing plate and the in-cell polarizing plate. More specifically, the negative C plate 56 is provided between the rear-side substrate 22 and the rear-side biaxial film 52. In the Comparison Configuration E, the retardation of the negative C plate 56 is 120 mm. This negative C plate retardation has been optimized for the liquid crystal display panel 10 equipped with the in-cell polarizing plate 50.

Optical Characteristics (Comparison Configurations D and E)

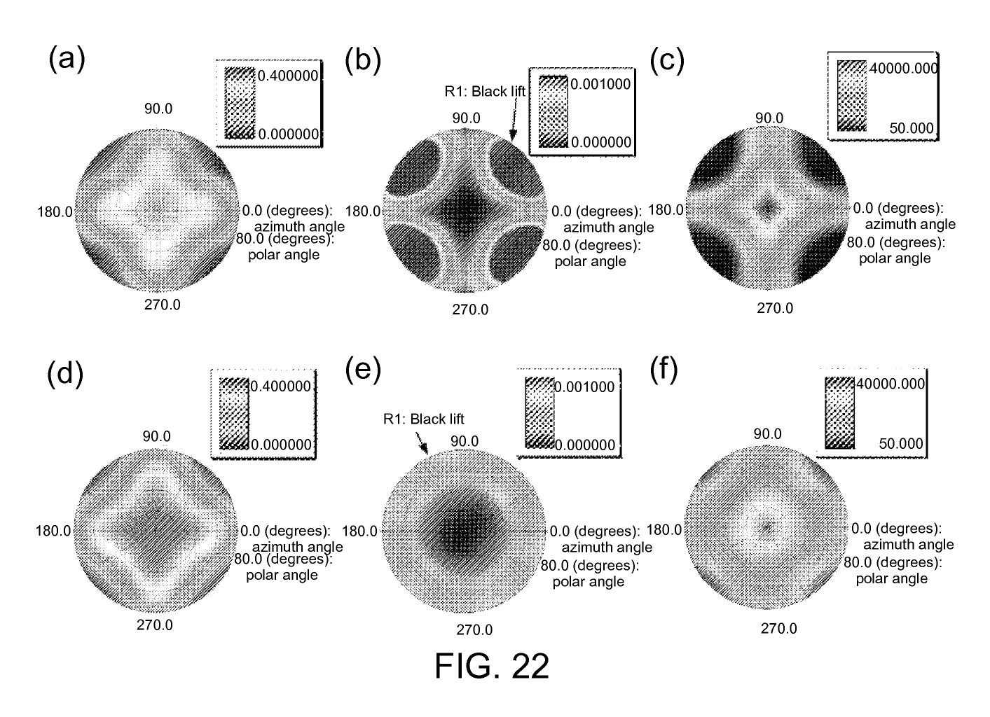

Below is provided an explanation of the optical characteristics of the liquid crystal display panel 10 of Comparison Configuration E with reference to FIGS. 22(a) to 22(f), while drawing comparisons with the optical characteristics of the liquid crystal display panel 10 of the Comparison Configuration D.

Here, FIGS. 22(a) to 22(c) show the optical characteristics of the liquid crystal display panel 10 of Comparison Configuration E, and FIGS. 22(d) to 22(f) show the optical characteristics of the liquid crystal display panel 10 of Comparison Configuration D.

FIGS. 22(a) and 22(d) show white luminance charts, FIGS. 22(b) and 22(e) show black luminance charts, and FIGS. 22(c) and 22(f) show iso-contrast charts.

First, as shown in FIGS. 22(d), 22(e), and 22(f), in the liquid crystal display panel 10 of the Comparison Configuration D, which is not provided with the in-cell polarizing plate 50, the occurrence of black lift or the like is suppressed, and high-quality viewing angle compensation is achieved using two layers of biaxial film.

In contrast, although the contrast of the liquid crystal display panel 10 of the Comparison Configuration E is not low (contrast=35900 (Ref (Comparison Configuration A) ratio 186%), as shown in FIG. 22(b) above, there is a significant amount of black lift R1, and sufficient viewing angle compensation is not achieved.

In other words, it can be said that with the configuration with two layers of biaxial film, even when the negative C plate 56 is provided at L2 between the rear-side polarizing plate and the in-cell polarizing plate, it is difficult to achieve a level of viewing angle compensation that is equivalent to that of the liquid crystal display panel 10 not provided with the in-cell polarizing plate 50.

### Summary

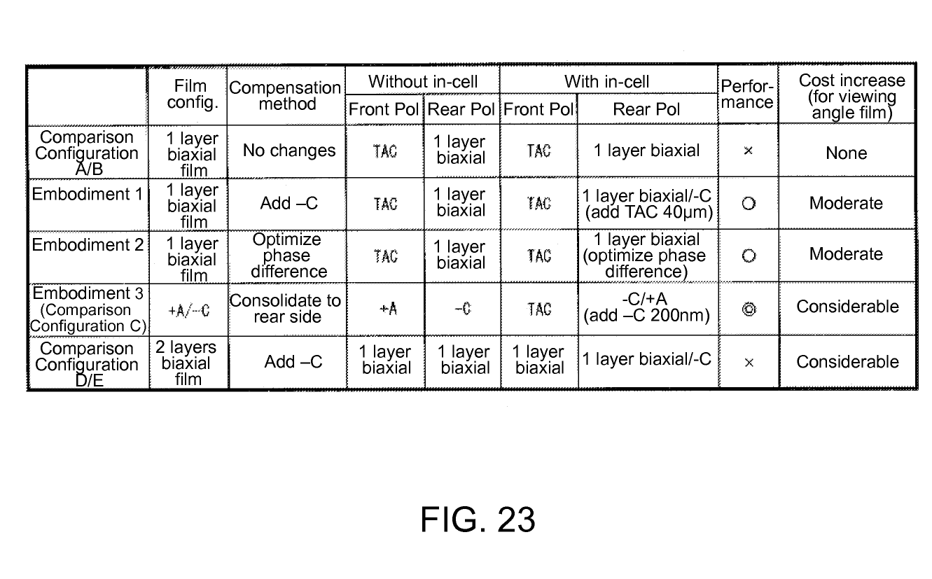

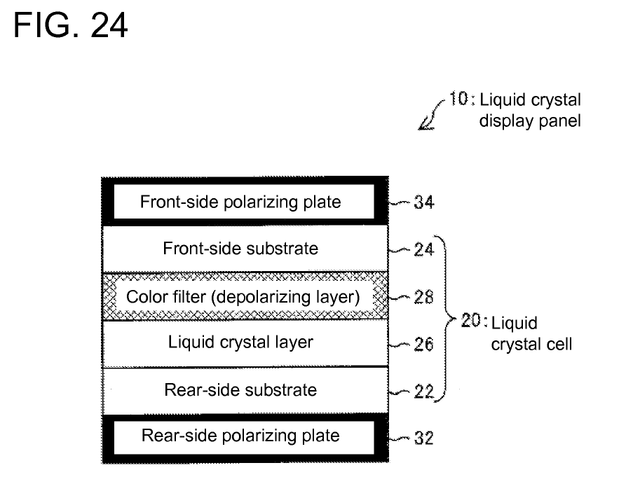

FIG. 23 is a diagram showing the characteristics of each of the embodiments and the comparison configurations described above.

As shown in FIG. 23, when an available 40 μm thick TAC is added to the configuration with a single layer of biaxial film, it is possible to achieve viewing angle compensation at low cost (see Embodiment 1).

It is also possible to achieve viewing angle compensation by improving the biaxial film phase difference design itself, without adding the TAC (see Embodiment 2).

It is possible to achieve high-quality optical characteristics by adding the 200 nm negative C plate to the configuration using the positive A plate and the negative C plate (see Embodiment 3).

Note also that it is difficult to achieve high-quality optical characteristics with the configuration that uses two layers of biaxial film, even when the negative C plate is added (see Comparison Configurations D and E.).

As described above, with each of the above embodiment configurations, high-quality viewing angle compensation was achieve on the liquid crystal display panels 10 that were provided with the in-cell polarizing plate 50.

Traditionally, in a liquid crystal display panel 10 that is not provided with an in-cell polarizing plate 50, it has been sufficient to cancel out the phase difference found at L1 between the outside polarizing plates. Thus, it was possible to design viewing angle (black) compensation by specifying the phase difference at the front-side polarizing plate 34 (TAC portion), the phase difference at the liquid crystal layer 26, and the phase difference at the rear-side polarizing plate (TAC portion), which broadened the margin for design.

In contrast, for the liquid crystal display panels 10 equipped with an in-cell polarizing plate 50, viewing angle compensation needs to be provided in L2 between the rear-side polarizing plate and the in-cell polarizing plate. When the viewing angle compensation is performed at L2 between the rear-side polarizing plate and the in-cell polarizing plate, the phase difference at the front-side polarizing plate 34 (TAC portion) cannot be compensated for. In other words, the phase difference of the front-side polarizing plate 34 remains as residual phase difference without being compensated for. And, this residual phase difference becomes the cause of the black lift.

In each of the embodiments above, even if the TAC portion of the phase difference of the front-side polarizing plate 34 remains, the design is such that high-quality black display can still be achieved.

In other words, if the phase difference compensation is completely performed at the passage of the in-cell polarizing plate 50 in the case where a TAC is provided as a protective film for the front-side polarizing plate 34, for example, the phase different at the TAC would be added, resulting in black lift after passing through the front-side polarizing plate 34.

The liquid crystal display panel 10 of the present invention is configured such that the compensation upon passage of the in-cell polarizing plate 50 is reduced to the extent that black list does not manifest, and as a result of adding the phase difference at the TAC, the compensation remains fairly strong in total. This way, a high-quality black display can be achieved.

More specifically, for example, it is preferable that the viewing angle compensation films be consolidated between the rear-side polarizing plate 32 and the in-cell polarizing plate 50; the compensation of the phase difference in the thickness direction upon passage of the in-cell polarizing plate 50 be set to −50 nm or more or −30 nm or less from the optimum value; and that the compensation of the phase difference in the thickness direction upon passage of the front-side polarizing plate 34 be set to +30 nm or more or +50 nm or less from the optimum value.

Here, TAC (with Rth being 50 nm or higher and 60 nm or lower) can be used as the front-side polarizing plate 34.

Also, when using a biaxial film as the viewing angle compensation film, it is preferable to set Rth of the viewing angle compensation film to 30 to 35 nm lower than the optimum value.

Further, when using a positive A plate and a negative C plate as the viewing angle compensation films, it is preferable to set the total Rth value of the viewing angle compensation to 40 to 50 nm lower than the optimum value.

Also, even better viewing angle characteristics can be achieved when the deviation from the optimum value upon passage of the in-cell polarizing plate 50 (insufficient portion) is set to be substantially equal to the total deviation (excess portion).

Furthermore, because the allowable range of the optimal phase difference (Re, Rth) is relatively narrow (10 nm), it is preferable to perform a very precise optical design.

Furthermore, it is preferable that the relationship between the residual phase difference and the optimum value described earlier fall within the specified range upon passage of either of the analyzer 1 and analyzer 2. Specifically, it is preferable to have the difference between the optimum value and the residual phase difference in the thickness direction remain within the range of ±30 to 50 nm.

Note also that the direction of the deviation between the optimum value described above and the residual phase difference in the thickness direction is a positive direction when passing through the analyzer 1 and is a negative direction when passing through the analyzer 2. This is because in order to effectuate optimum optical compensation inclusive of a negative phase difference between analyzer 1 and analyzer 2, a slight offset is provided in an opposite direction from the optimum value.

Another feature of the liquid crystal display panel of the present invention is that the difference between the phase difference value in the thickness direction of the liquid crystal layer between the first polarizing plate and the in-cell polarizing plate and the phase difference value in the thickness direction of the liquid crystal layer between the first polarizing plate and the second polarizing plate is no less than 60 nm and no more than 100 nm.

The configuration described above can achieve high-quality viewing angle compensation because when the difference between the two phase difference values is no less than 60 nm and no more than 100 nm, the difference value has been optimized.

Another feature of the liquid crystal display panel of the present invention is that the phase difference value of the liquid crystal layer in the thickness direction between the first polarizing plate and the in-cell polarizing plate described above is at least +30 nm but no more than +50 nm from the optimum value of the phase difference for the viewing angle compensation.

Yet another feature of the liquid crystal display panel of the present invention is that the phase difference value of the liquid crystal layer in the thickness direction is at least −50 nm but no more than −30 nm from the optimum value of the phase difference for the viewing angle compensation.

Yet another feature of the liquid crystal display panel of the present invention is that when the difference between the phase difference value (in the thickness direction of the liquid crystal layer) between the first polarizing plate and the in-cell polarizing plate and the optimum value of the phase difference for the viewing angle compensation is added to the difference between the phase difference (in the thickness direction of the liquid crystal layer) between the first polarizing plate and the second polarizing plate and the optimum value of the phase difference for the viewing angle compensation, the resulting value is no less than −10 nm and no more than +10 nm.

Here, the term “optimum value of the phase difference for the viewing angle compensation” means a phase difference value in the thickness direction of the liquid crystal layer and an in-plane phase difference value between the first polarizer and the second polarizer such that with these values, the polarized light entering from the polarizer to the analyzer have a polarized state that matches the absorption axis of the analyzer.

In the liquid crystal display panel that is provided with a first polarizing plate, a second polarizing plate, and an in-cell polarizing plate, the first polarizing plate acts as a polarizer, while the in-cell polarizing plate acts as analyzer 1 and the second polarizing plate acts as analyzer 2.

With the configurations described above, the phase difference value upon entrance of the in-cell polarizing plate, which serves as analyzer 1, is no less than +30 nm and no more than +50 nm from the optimum value.

With the above configurations described above, the phase difference value upon entrance of the second polarizing plate, which serves as analyzer 2 is no less than −50 nm and no more than −30 nm from the optimum value.

Further, with the above configurations, the sum of the residual phase difference value at analyzer 1 (the in-cell polarizing plate) and the residual phase difference value at analyzer 2 (the second polarizing plate) is close to zero. In other words, the absolute values of the residual phase values are nearly the same.

Accordingly, deviations from the optimum value are equally distributed to the analyzer 1 (the in-cell polarizing plate) and the analyzer 2 (the second polarizing plate), thereby ensuring effective compensation. Then, even if there is a phase difference between analyzer 1 and analyzer 2, it is easy to perform high-quality viewing angle compensation.

Another feature of the liquid crystal display panel of the present invention is that a biaxial film and a negative C plate are provided as viewing angle compensation films between the first polarizing plate and the in-cell polarizing plate.

With the above configuration, the biaxial film and the negative C plate are used as the viewing angle compensation films for the first polarizing plate and the in-cell polarizing plate.

In other words, with the above configuration, the viewing angle compensation can be achieved by just adding the negative C plate to the biaxial film.

Here, the term “negative C plate” means a uniaxial plate (film) that is optically negative and, more specifically, a plate which has the following relationship: nx=ny>nz (where n indicates the refractive index, x*y represent the in-plane axis directions on the plate and z means the direction of the axis of the plate thickness.

As the negative C plate described above, an existing substance like TAC (triacetyl cellulose), for example, can be used.

For that reason, it is possible to perform the viewing angle compensation easily without having to procure a new material.

In the liquid crystal display panels of the present invention, only the biaxial film is provided between the first polarizing plate and the in-cell polarizing plate as a viewing angle compensation film.

Another feature of the liquid crystal display panel of the present invention is that the value of the phase difference (in the thickness direction of the liquid crystal layer) of the biaxial film is no less than −35 nm and no more than −30 nm from the optimum value of the phase difference for the viewing angle compensation.

With the above configuration, it is possible to perform viewing angle compensation with a simple configuration, using only the biaxial film as the viewing angle compensation film between the first polarizing plate and the in-cell polarizing plate.

Yet another feature of the liquid crystal display panel of the present invention is that a positive A plate and a negative C plate are provided as a viewing angle compensation film between the first polarizing plate and the in-cell polarizing plate.

Yet another feature of the liquid crystal display panel of the present invention is that the sum of the phase difference value (in the thickness direction of the liquid crystal layer) of the positive A plate and the phase difference value (in the thickness direction of the liquid crystal layer) of the negative C plate is no less than −50 nm and no more than −40 nm from the optimum value of the phase difference for the viewing angle compensation.

Here, the term “positive A plate” means an optically positive uniaxial plate (film), and more specifically, it means a plate that has the following relationship: nx>ny=nx (where n indicates the refractive index, x*y are the directions of the in-plane axes of the plate, and z represents the axis direction of the plate thickness).

The above configuration provides very high-quality viewing angle compensation by simply adding the negative C plate described earlier to the positive A plate, which sometimes is used as the viewing angle compensation film in a liquid crystal display panel that does not have an in-cell polarizing plate.

Another feature of the liquid crystal display panel of the present invention is that a negative C plate has been provided between the in-cell polarizing plate and the second polarizing plate described above.

Another feature of the liquid crystal display panel of the present invention is that the negative C plate described above and provided between the in-cell polarizing plate and the second polarizing plate is TAC.

The above configuration makes it possible to achieve higher-quality viewing angle compensation because the negative C plate is provided between the in-cell polarizing plate and the second polarizing plate. And, it is possible to use TAC or some other substance that is readily available for the negative C plate.

Another feature of the liquid crystal display panel of the present invention is that a protective film for the second polarizing plate is provided between the in-cell polarizing plate and the second polarizing plate; the absolute value of the phase difference (in the thickness direction of the liquid crystal layer) of the protective film is 5 nm or less; and the absolute value of the difference between the phase difference value (in the thickness direction of the liquid crystal layer) between the first polarizing plate and the second polarizing plate and the optimum phase difference value for the viewing angle compensation is 5 nm or less.

A film with a phase difference in the thickness direction being almost zero is used as the protective film for the second polarizing plate according to the configuration above.

Because of this, after the light passes through the in-cell polarizing plate and before it enters the second polarizing plate, its polarized state will not change easily. Therefore, it is possible to realize a high-quality viewing angle compensation by providing a viewing angle compensation film (phase difference film) such that the value of the phase difference (in the thickness direction of the liquid crystal layer) between the first polarizing plate and the second polarizing plate is essentially equivalent to the optimum value of the phase difference for the viewing angle compensation.

Another feature of the liquid crystal display panel of the present invention is that a color filter is provided between the second substrate and the in-cell polarizing plate.

With the above configuration, even when a color filter that functions as a depolarizing layer is provided for a color display, it is possible to configure a polarizer and an analyzer without having to go through the depolarizing layer, as explained above.

Thus, it is possible to suppress the deterioration in contrast caused by transmission through the depolarizing layer.

The present invention is not limited to the embodiments described above and there are a variety of possible modifications within the scope of claims presented herein, and embodiments that can be achieved by combining the various technical means disclosed in the different embodiments are also included in the technical scope of the present invention.

### INDUSTRIAL APPLICABILITY

The liquid crystal display panel of the present invention has high contrast not only from the front but also in oblique directions so it can be used suitably, particularly in applications that require a broad viewing angle or a high-quality display.

### DESCRIPTION OF REFERENCE CHARACTERS

10 Liquid crystal display panel

20 Liquid crystal cell

22 Rear-side substrate (first substrate)

24 Front-side substrate (second substrate)

26 Liquid crystal layer

28 Color filter

32 Rear-side polarizing plate (first polarizing plate)

34 Front-side polarizing plate (second polarizing plate)

36 Rear-side phase difference film (viewing angle compensation film)

50 In-cell polarizing plate

52 Rear-side biaxial film (viewing angle compensation film)

56 Negative C plate (viewing angle compensation film)

58 Positive A plate (viewing angle compensation film)

1. A liquid crystal display panel comprising a first substrate, a second substrate, and a liquid crystal layer held between said first substrate and said second substrate,
wherein a first polarizing plate is provided on an outside of said first substrate on a side not facing said liquid crystal layer,
wherein a second polarizing plate is provided on an outside of said second substrate on a side not facing said liquid crystal layer,
wherein an in-cell polarizing plate is provided between said second substrate and said liquid crystal layer on a side of said second substrate facing said liquid crystal layer,
wherein a viewing angle compensation film is provided between said first polarizing plate and said in-cell polarizing plate, and
wherein a phase difference value in the thickness direction of said liquid crystal layer between said first polarizing plate and said second polarizing plate is smaller than a phase difference value in the thickness direction of said liquid crystal layer between said first polarizing plate and said in-cell polarizing plate.

2. The liquid crystal display panel according to claim 1, wherein a difference between the phase difference value in the thickness direction of the liquid crystal layer between said first polarizing plate and said in-cell polarizing plate and the phase difference value in the thickness direction of said liquid crystal layer between said first polarizing plate and said second polarizing plate is no less than 60 nm and no more than 100 nm.

3. The liquid crystal display panel according to claim 1, wherein the phase difference value in the thickness direction of said liquid crystal layer between said first polarizing plate and said in-cell polarizing plate is no less than +30 nm and no more than +50 nm from an optimum phase difference value for viewing angle compensation.

4. The liquid crystal display panel according to claim 1, wherein the phase difference value in the thickness direction of said liquid crystal layer between said first polarizing plate and said second polarizing plate is no less than −50 nm and no more than −30 nm from an optimum phase difference value for viewing angle compensation.

5. The liquid crystal display panel according to claim 1, wherein the sum of (i) a difference between the phase difference value in the thickness direction of said liquid crystal layer between said first polarizing plate and said in-cell polarizing plate and an optimum phase difference value for viewing angle compensation, and (ii) a difference between the phase difference value in the thickness direction of the liquid crystal layer between said first polarizing plate and said second polarizing plate and an optimum phase difference value for viewing angle compensation is no less than −10 nm and no more than +10 nm.

6. The liquid crystal display panel according to claim 1, wherein a biaxial film and a negative C plate are provided as said viewing angle compensation film between said first polarizing plate and said in-cell polarizing plate.

7. The liquid crystal display panel according to claim 1, wherein only a biaxial film is provided as said viewing angle compensation film between said first polarizing plate and said in-cell polarizing plate.

8. The liquid crystal display panel according to claim 7, wherein a phase difference value in the thickness direction of said liquid crystal layer of said biaxial film is no less than −35 nm and no more than −30 nm from an optimum phase difference value for viewing angle compensation.

9. The liquid crystal display panel according to claim 1, wherein a positive A plate and a negative C plate are provided as said viewing angle compensation film between said first polarizing plate and said in-cell polarizing plate.

10. The liquid crystal display panel according to claim 9, wherein the sum of a phase difference value in the thickness direction of said liquid crystal layer of said positive A plate and a phase difference value in the thickness direction of said liquid crystal layer of said negative C plate is no less than −50 nm and no more than −40 nm from an optimum phase difference value for viewing angle compensation.

11. The liquid crystal display panel according to claim 6, wherein a negative C plate is provided between said in-cell polarizing plate and said second polarizing plate.

12. The liquid crystal display panel according to claim 11, wherein said negative C plate provided between said in-cell polarizing plate and said second polarizing plate is TAC.

13. The liquid crystal display panel according to claim 1,
wherein a protective film for said second polarizing plate is provided between said in-cell polarizing plate and said second polarizing plate,
wherein the absolute value of a phase difference value in the thickness direction of said liquid crystal layer of said protective film is 5 nm or less, and
wherein the absolute value of a difference between the phase difference value in the thickness direction of said liquid crystal layer between said first polarizing plate and said second polarizing plate and an optimum phase difference value for viewing angle compensation is no more than 5 nm.

14. The liquid crystal display panel according to claim 1, wherein a color filter is provided between said second substrate and said in-cell polarizing plate.
